(19) United States
(12) Patent Application Publication
(10) Pub. No.: US 2026/0296043 A1
(43) Pub. Date: Oct. 1, 2026

(54) PRINTING APPARATUS

(71) Applicant: CANON KABUSHIKI KAISHA, Tokyo (JP)

(72) Inventors: MASAHARU UEDA, Kanagawa (JP); MASAKAZU NAGASHIMA, Kanagawa (JP); TAKUYA HANE, Kanagawa (JP); HIROMASA YONEYAMA, Kanagawa (JP); SEIJI SUZUKI, Kanagawa (JP)

(21) Appl. No.: 19/573,423

(22) Filed: Mar. 20, 2026

(30) Foreign Application Priority Data
Mar. 28, 2025 (JP) 2025-056656

(51) Int. Cl. B41J 2/175; B41J 2/19

(52) U.S. Cl. CPC B41J 2/17596; B41J 2/19

(57) ABSTRACT

A printing apparatus includes a printing head configured to eject a liquid to print an image, a tank configured to store the liquid to be supplied to the printing head, a supply channel connected to the printing head and the tank, and a plurality of pumps configured to send the liquid stored in the tank to the printing head through the supply channel. The supply channel has a plurality of branching flow passages configured to branch off and merge midway through the supply channel, and a pump is provided in each of the plurality of branching flow passages.

### BACKGROUND

This application claims the benefit of Japanese Patent Application No. 2025-056656, filed March 28, 2025, which is hereby incorporated by reference herein in its entirety.

### FIELD OF THE TECHNOLOGY

The present disclosure relates to a printing apparatus.

### DESCRIPTION OF THE RELATED ART

Some printing apparatuses print images by ejecting a liquid such as ink from a printing head. For example, a printing apparatus disclosed in Japanese Patent Laid-Open No. 2022-82329 includes a reservoir, a printing head, a supply channel, a deaeration unit, and a temperature regulating unit. The reservoir stores a liquid such as ink. The printing head ejects ink supplied from the reservoir. The supply channel connects the reservoir to the printing head. The deaeration unit removes air bubbles contained in the ink flowing through the supply channel. The temperature regulating unit is provided between the reservoir and the deaeration unit to regulate the temperature of the ink flowing through the supply channel. A high-pressure side channel and a low-pressure side channel are provided inside the printing head, with a difference in pressure between the channels. The high-pressure side channel is connected to the low-pressure side channel through upstream and downstream portions of an ink ejection part of the printing head. This allows the ink supplied to the ink ejection part to circulate using the pressure difference between the channels described above. The supply channel for supplying ink from the reservoir to the printing head and a collecting channel for returning the ink from the printing head to the reservoir are each provided with a pump.

To improve the printing speed, the flow rate of ink supplied to the printing head needs to be increased.

### SUMMARY

The present disclosure is directed to a printing apparatus capable of increasing the flow rate of a liquid supplied to a printing head while ensuring pump installation space.

A printing apparatus according to an aspect of the present disclosure includes: a printing head configured to eject a liquid to print an image; a tank configured to store the liquid supplied to the printing head; a supply channel connected to the printing head and the tank; and a plurality of pumps configured to send the liquid stored in the tank to the printing head through the supply channel. The supply channel has a plurality of branching flow passages configured to branch off and merge midway through the supply channel, and a pump is provided in each of the plurality of branching flow passages.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram showing an example of an overall configuration of a printing apparatus;

FIG. 2 is a perspective view showing an example of a printing head;

FIG. 3 is a schematic diagram showing a circulation liquid channel;

FIG. 4 is a schematic diagram showing a liquid circulation path inside the printing head;

FIG. 5 is a block diagram showing a control unit;

FIG. 6 is a schematic diagram showing a comparative example of the circulation liquid channel;

FIG. 7 is a flowchart showing a flow of an ink filling operation;

FIG. 8 is an explanatory diagram showing a capping state of a cap;

FIG. 9 is an explanatory diagram showing a state where ink is filled up to a first pump and a second pump;

FIG. 10 is an explanatory diagram showing a state where ink is filled up to a part of a supply channel past a choke valve;

FIG. 11 is an explanatory diagram showing a state where only the first pump is in operation;

FIG. 12 is an explanatory diagram showing a state where only the second pump is in operation;

FIG. 13 is an explanatory diagram showing a state where the ink is filled in the supply channel and the printing head;

FIG. 14 is an explanatory diagram showing a state where the ink is filled in a collecting channel, in addition to the supply channel and the printing head;

FIG. 15 is a flowchart showing a flow of a deaeration operation;

FIG. 16 is an explanatory diagram showing a state where the first pump and the second pump are in operation during the deaeration operation;

FIG. 17 is a schematic diagram showing a circulation liquid channel in a second embodiment;

FIG. 18 is a flowchart showing a flow of an ink filling operation in the second embodiment;

FIG. 19 is a flowchart showing the flow of the ink filling operation in the second embodiment;

FIG. 20 is an explanatory diagram showing a state where only a first pump is in operation;

FIG. 21 is a flowchart showing a flow of a deaeration operation in the second embodiment; and

FIG. 22 is an explanatory diagram showing a state where first to third pumps are in operation during the deaeration operation.

### DESCRIPTION OF THE EMBODIMENTS

Preferred embodiments of the present disclosure will be described in detail below with reference to the attached drawings. Note that the following embodiments do not limit the scope of the present disclosure, and not all combinations of features described in the following embodiments are necessarily essential to the solutions of the present disclosure. Note that the same parts will be denoted by the same reference numerals.

### <<FIRST EMBODIMENT>>

### <Overall Configuration of Printing Apparatus>

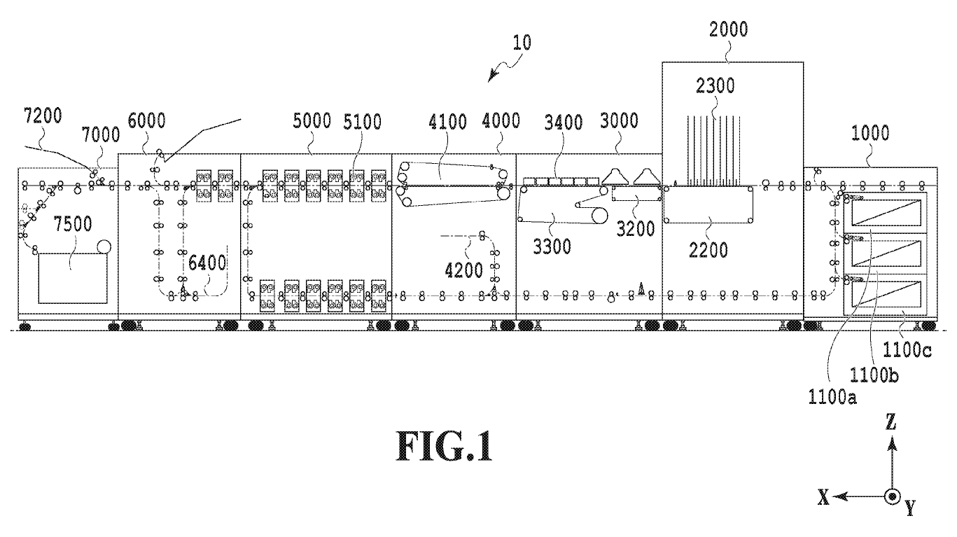

An overall configuration of a printing apparatus 10 in the present embodiment will be described below with reference to the drawings. In each drawing, arrows X and Y indicate horizontal directions orthogonal to each other, and an arrow Z indicates a vertical direction. The X direction is generally a conveyance direction in which a sheet S as a printing medium is conveyed inside the printing apparatus 10, and specifically corresponds to a conveyance direction in which the sheet S is conveyed in a printing unit 2300. In FIG. 1, the top of the apparatus is defined as the upper side and the right-to-left direction as a longitudinal direction. In addition, the front-to-back direction of the page space orthogonal to the sheet conveyance direction is defined as a sheet width direction. The front side of the page space is the front side of the apparatus, and the back side of the page space is the rear side of the apparatus.

FIG. 1 is a schematic diagram showing an example of an overall configuration of the printing apparatus 10. The printing apparatus 10 is a sheet-fed printing apparatus for producing a printed product by forming an ink image (image) on the sheet S using two types of liquids, a reaction liquid and ink. The printing apparatus 10 of the present embodiment includes a sheet feed module 1000, a print module 2000, a drying module 3000, a fixing module 4000, a cooling module 5000, an inversion module 6000, and a discharge stacking module 7000. The cut sheet S supplied from the sheet feed module 1000 is conveyed along a conveyance path, processed in each module, and discharged to the discharge stacking module 7000.

The sheet feed module 1000 is equipped with three storage containers 1100a to 1100c for accommodating the sheets S. The storage containers 1100a to 1100c can each be pulled out toward the apparatus front side (front side of the page space). The sheets S are fed one by one by a separation belt and conveyance rollers in each of the storage containers 1100a to 1100c, and then conveyed to the print module 2000. The number of the storage containers 1100a to 1100c is not limited to three, but the configuration may include one, two, or four or more storage containers.

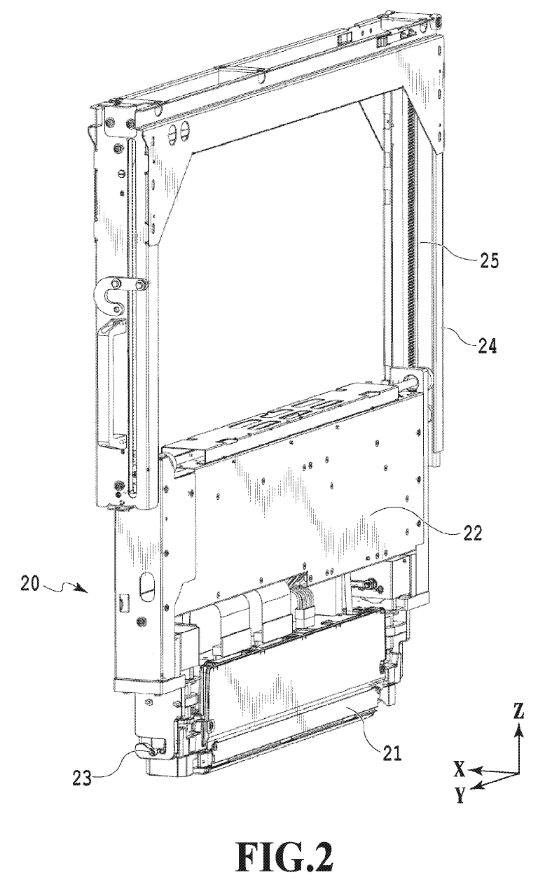

The print module 2000 includes a pre-imaging registration correction unit (not shown), a print belt unit 2200, and the printing unit 2300. The pre-imaging registration correction unit corrects the tilt and position of the sheet S conveyed from the sheet feed module 1000, and the sheet S is then conveyed to the print belt unit 2200. The printing unit 2300 is disposed facing the print belt unit 2200 along the conveyance path of the sheet S. The printing unit 2300 performs a printing process (print processing) on the conveyed sheet S from above using a printing head 21 (see FIG. 2) to form an image on the sheet S. The sheet S is sucked and conveyed by the print belt unit 2200, ensuring clearance with the printing head 21. A plurality of the printing heads 21 are arranged in the conveyance direction (X direction).

FIG. 2 is a perspective view showing an example of the printing head 21. The printing unit 2300 of the present embodiment has the plurality of printing heads 21, and FIG. 2 shows one of the printing heads 21. As shown in FIG. 2, the printing head 21 has a printing head supporting shaft 23. The printing head 21 is pivotally supported by a printing head holding portion 22 for vertically elevating and lowering the printing head 21 while holding the printing head 21, such that the printing head holding portion 22 supports the printing head supporting shaft 23 from below. The printing head holding portion 22 is elevated and lowered vertically (in the Z direction) along elevating and lowering rails 25 provided in a printing head elevating and lowering frame 24 by a drive mechanism (not shown) that serves as a head moving unit provided internally. Hereinafter, the printing head 21 and the printing head holding portion 22 will be collectively referred to as a head unit 20.

A lowered position of the head unit 20 is a printing position where the printing head 21 performs printing. An elevated position of the head unit 20 higher than the printing position is a retracted position where the printing head 21 is retracted. Between the printing position and the retracted position, there is a maintenance position for performing maintenance of the printing head 21. In the present embodiment, the head unit 20 is configured to be movable to the three positions, but may be configured to be movable to two or more positions. For example, the retracted position and the maintenance position may be the same position.

Continuing with the description of FIG. 1, the printing unit 2300 of the present embodiment has a total of five line-type printing heads 21 corresponding to four colors of Y (yellow), M (magenta), C (cyan), and Bk (black), as well as a reaction liquid. Note that the number of colors and the number of printing heads are not limited to five. As an inkjet method, a method using heating elements, a method using piezoelectric elements, a method using electrostatic elements, a method using MEMS elements, or the like can be adopted. Ink of each color is supplied to the printing head 21 from an ink tank (not shown) through an ink tube.

The sheet S printed in the printing unit 2300 is conveyed by the print belt unit 2200. An in-line scanner (not shown) disposed downstream of the printing unit 2300 in the conveyance direction detects misalignment and color density of the image formed on the sheet S, allowing the printed image to be corrected.

The drying module 3000 includes a decoupling unit 3200, a drying belt unit 3300, and a hot air blowing unit 3400. The drying module 3000 reduces liquid components contained in the ink applied onto the sheet S in the printing unit 2300 to improve fixability of the sheet S and the ink. The sheet S printed in the printing unit 2300 of the print module 2000 is conveyed to the decoupling unit 3200 disposed inside the drying module 3000. The decoupling unit 3200 can convey the sheet S by using air pressure from above and belt friction. By loosely holding and conveying the sheet S on the belt, misalignment of the sheet S can be reduced on the print belt unit 2200 where an ink image is formed. The sheet S conveyed from the decoupling unit 3200 is sucked and conveyed by the drying belt unit 3300, while hot air is blown onto the sheet from the hot air blowing unit 3400 disposed above the belt. Accordingly, the ink-applied surface of the sheet S is dried. Besides the method of blowing hot air, the drying method may also be combined with a method of irradiating the surface of the sheet S with electromagnetic waves (such as ultraviolet or infrared rays) or a conductive heat transfer method using contact with a heating element. To improve drying efficiency, the above method may also be used to apply heat to the surface of the sheet S opposite to the ink-applied surface.

The fixing module 4000 has a fixing belt unit 4100. The fixing belt unit 4100 has an upper belt unit and a lower belt unit. By passing the sheet S conveyed from the drying module 3000 between the heated upper and lower belt units, the ink can be fixed to the sheet S.

The cooling module 5000 has a plurality of cooling units 5100. The cooling units 5100 cool the hot sheet S conveyed from the fixing module 4000. The cooling units 5100 use a fan to draw outside air into a cooling box, increasing the pressure inside the cooling box, and cool the sheet S by blowing air pouring forth from nozzles formed in a conveyance guide against the sheet S. The cooling units 5100 are disposed on both sides of the conveyance path, and capable of cooling the sheet S from both sides. The cooling module 5000 also includes a conveyance path switching unit capable of switching the conveyance path of the sheet S, depending on whether the sheet S is conveyed to the inversion module 6000 or to a duplex conveyance path used for duplex printing. During the duplex printing, the sheet S is conveyed to the conveyance path below the cooling module 5000 and further conveyed along the duplex conveyance path of the fixing module 4000, drying module 3000, print module 2000, and sheet feed module 1000. The sheet S is then conveyed again to the pre-imaging registration correction unit, the print belt unit 2200, and the printing unit 2300 in the print module 2000, and the printing unit 2300 performs printing. A duplex conveyance unit of the fixing module 4000 is provided with an inversion unit 4200 configured to invert the sheet S.

The inversion module 6000 includes an inversion unit 6400. The inversion module 6000 can invert the conveyed sheet S, using the inversion unit 6400, and freely switch between two sides of the sheet S to be discharged.

The discharge stacking module 7000 has a top tray 7200 and a stacking unit 7500, and aligns and stacks the sheets S conveyed from the inversion module 6000.

### < Configuration of Circulation Unit>

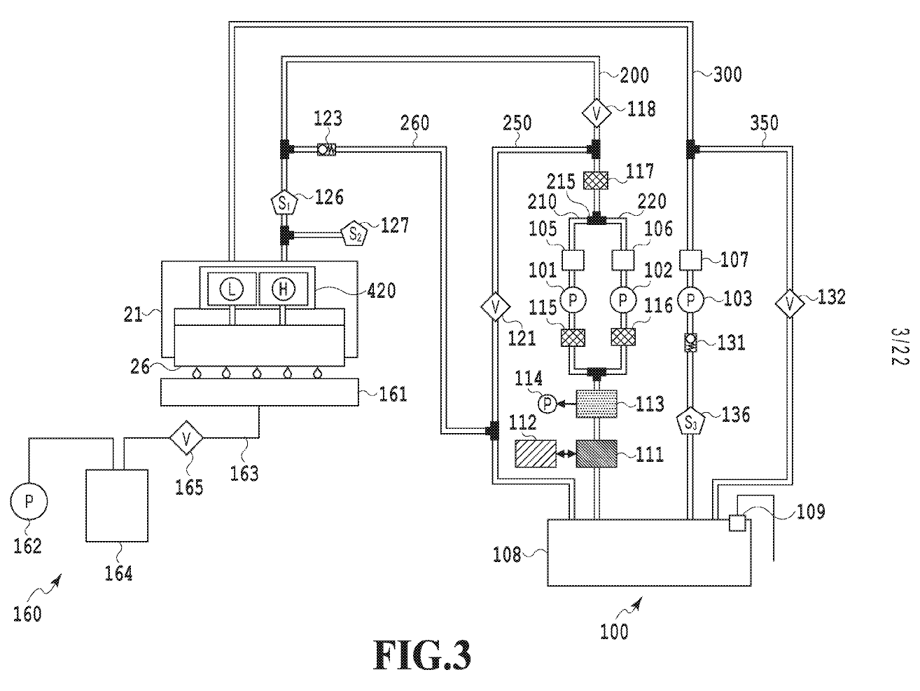

FIG. 3 is a schematic diagram showing a circulation liquid channel including a circulation unit 100 for supplying ink to the printing head 21. Note that the following description is given of a printing head configured to eject ink as an example, but the same applies to a printing head configured to eject a liquid such as a reaction liquid. The circulation unit 100 of the present embodiment includes a first pump 101, a second pump 102, a third pump 103, a first conduit section 105, a second conduit section 106, a third conduit section 107, and a buffer tank 108. The circulation unit 100 also includes a heat exchanger 111, a deaeration module 113, a first filter 115, a second filter 116, a third filter 117, and a choke valve 118. The circulation unit 100 also includes a first solenoid valve 121, a relief valve 123, a check valve 131, and a second solenoid valve 132. The components of the circulation unit 100 may be connected directly or through resin or metal piping.

The buffer tank 108 is a reservoir for storing ink supplied from an ink tank (not shown). A supply channel 200 is connected to the buffer tank 108 to supply ink to the printing head 21. A first branching flow passage 210 and a second branching flow passage 220 are formed in part of the supply channel 200 and configured to branch off and merge midway through the supply channel 200. A collecting channel 300 is also connected to the buffer tank 108 to collect ink not ejected from ejection ports of the printing head 21. A supply-side air communicating channel 250 and a relief channel 260 branched off from the supply channel 200 are connected to the buffer tank 108. A collection-side air communicating channel 350 branched off from the collecting channel 300 is connected to the buffer tank 108.

The supply channel 200, the supply-side air communicating channel 250, the relief channel 260, the collecting channel 300, and the collection-side air communicating channel 350 form a circulation liquid channel for supplying and circulating ink to the printing head 21. The buffer tank 108 is also provided with an air communicating port 109 for stabilizing the pressure inside the circulation liquid channel. The inside of the buffer tank 108 is communicated with the outside air through the air communicating port 109. The buffer tank 108 is provided with a weight sensor (not shown) to detect the weight of the buffer tank 108.

In the supply channel 200, the heat exchanger 111, the deaeration module 113, the first branching flow passage 210, the second branching flow passage 220, the third filter 117, and the choke valve 118 are disposed in this order from the buffer tank 108 side. In the first branching flow passage 210, the first filter 115, the first pump 101, and the first conduit section 105 are disposed in this order from the buffer tank 108 side. In the second branching flow passage 220, the second filter 116, the second pump 102, and the second conduit section 106 are disposed in this order from the buffer tank 108 side.

The heat exchanger 111 is a temperature regulating unit configured to regulate the temperature of the ink, together with a temperature regulator 112. The heat exchanger 111 exchanges heat between the ink and a constant-temperature medium in the heat exchanger 111. The constant-temperature medium circulates between the heat exchanger 111 and the temperature regulator 112, and the temperature of the ink is regulated by the temperature regulator 112.

The deaeration module 113 is a deaeration unit for removing gas dissolved in the ink. The deaeration module 113 is connected to a pressure-reducing pump 114 disposed outside the circulation unit 100. A porous hollow fiber membrane is provided inside the deaeration module 113. The deaeration module 113 is capable of reducing the pressure inside the hollow fiber membrane by operating the pressure-reducing pump 114. As the ink flows into the deaeration module 113 with the pressure inside the hollow fiber membrane reduced by the pressure-reducing pump 114, the gas (dissolved oxygen) dissolved in the ink is sucked into the hollow fiber membrane and discharged to the outside by the pressure-reducing pump 114. This allows deaerated ink to be supplied to the printing head 21.

The first filter 115 has a function to filter ink containing foreign matter of about several μm in size in the first branching flow passage 210. The first filter 115 captures sticking matter formed in the first branching flow passage 210 and foreign matter mixed into the ink, thereby suppressing the sticking matter and foreign matter from being mixed into the printing head 21. The second filter 116 has a function to filter ink containing foreign matter of about several μm in size in the second branching flow passage 220. The second filter 116 captures sticking matter in the second branching flow passage 220 and foreign matter mixed into the ink, thereby suppressing the sticking matter and foreign matter from being mixed into the printing head 21.

The first pump 101 sends the ink stored in the buffer tank 108 to the printing head 21 through the first conduit section 105 disposed in the supply channel 200 (first branching flow passage 210). The second pump 102 sends the ink stored in the buffer tank 108 to the printing head 21 through the second conduit section 106 disposed in the supply channel 200 (second branching flow passage 220). The first pump 101 and the second pump 102 are configured using diaphragm pumps, for example.

The cross-section area of the internal space of the first conduit section 105 is larger than the cross-section area of the first branching flow passage 210. This allows the first conduit section 105 to reduce pulsation generated as the first pump 101 sends the ink. The cross-section area of the internal space of the second conduit section 106 is larger than the cross-section area of the second branching flow passage 220. This allows the second conduit section 106 to reduce pulsation generated as the second pump 102 sends the ink. In the present embodiment, the cross sections and cross-section areas of the internal spaces of the first conduit section 105, the second conduit section 106, and the like are those in a direction intersecting (in the present embodiment, orthogonal to) the extending direction of the first conduit section 105, the second conduit section 106, and the like.

The third filter 117 has a function to filter ink containing foreign matter of about several μm in size in a flow path between the choke valve 118 and the first and second branching flow passages 210 and 220 in the supply channel 200. The third filter 117 captures sticking matter, foreign matter and the like that are not captured by the first filter 115 and the second filter 116, thereby suppressing the sticking matter and foreign matter from being mixed into the printing head 21. The third filter 117 may be a filter having a pore size different from those of the first filter 115 and the second filter 116.

The choke valve 118 is a solenoid valve for applying negative pressure to the printing head 21 and the circulation liquid channel through a cap 161 of a recovery unit 160 as the ink is filled in the printing head 21 and the circulation liquid channel. The choke valve 118 is disposed in a portion of the supply channel 200 between the printing head 21 and the first and second conduit sections 105 and 106 (a junction 215 between the first branching flow passage 210 and the second branching flow passage 220). A temperature sensor 126 and a pressure sensor 127 are also disposed in a portion of the supply channel 200 between the choke valve 118 and the printing head 21.

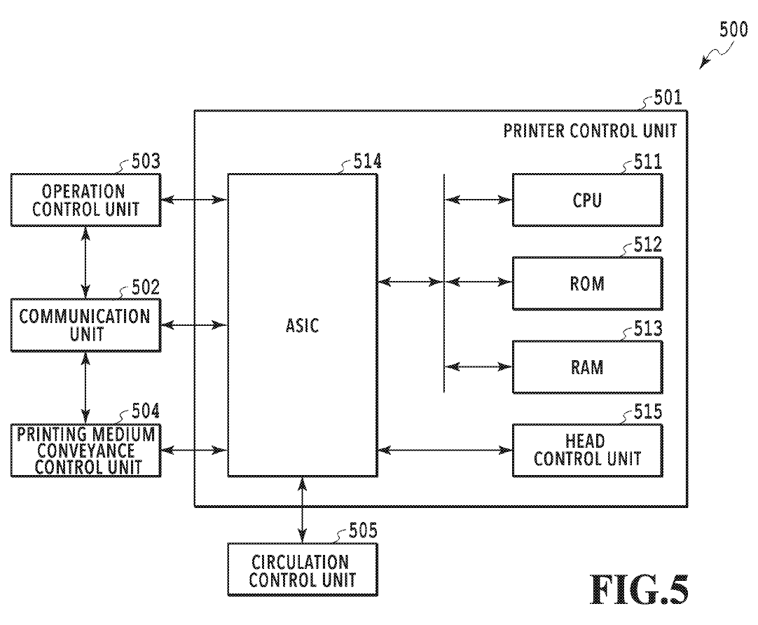

The temperature sensor 126 is a sensor for monitoring the temperature of the ink supplied to the printing head 21 by a printer control unit 501 (see FIG. 5 described below) or the like. For example, if a temperature value detected by the temperature sensor 126 falls outside a predetermined temperature range, the printer control unit 501 performs control to warn a user to change the temperature setting of the temperature regulator 112.

The pressure sensor 127 is a sensor for monitoring the pressure applied to the printing head 21 from the supply channel 200 by a circulation control unit 505 (see FIG. 5 described below). The circulation control unit 505 performs control to change a drive frequency of the first pump 101 or the second pump 102 by sending a control signal to the first pump 101 or the second pump 102, so that the pressure value detected by the pressure sensor 127 falls within a predetermined pressure range. If the pressure value detected by the pressure sensor 127 falls outside the predetermined pressure range even after the drive frequency is changed, the circulation control unit 505 detects an abnormality in the supply channel 200 and controls the circulation unit 100 to stop circulating the ink.

The supply-side air communicating channel 250 is a channel for releasing the pressure inside the supply channel 200 to atmospheric pressure as the ink circulation stops. The supply-side air communicating channel 250 branches off from a portion of the supply channel 200 between the third filter 117 (the junction 215 between the first branching flow passage 210 and the second branching flow passage 220) and the choke valve 118, and is connected to the buffer tank 108. The first solenoid valve 121 is disposed in the supply-side air communicating channel 250. The pressure inside the supply channel 200 is released to the atmospheric pressure through the supply-side air communicating channel 250, the buffer tank 108, and the air communicating port 109 by the first solenoid valve 121 opening the supply-side air communicating channel 250 as the ink circulation stops.

The relief channel 260 is a channel for releasing excess pressure applied to the printing head 21. The relief channel 260 branches off from a portion of the supply channel 200 between the choke valve 118 and the printing head 21 (temperature sensor 126) and is connected to the buffer tank 108. The relief valve 123 is disposed in the relief channel 260. If the pressure inside the relief channel 260 is below a predetermined pressure, the relief valve 123 closes the relief channel 260. If the pressure inside the relief channel 260 is greater than or equal to the predetermined pressure, the relief valve 123 opens the relief channel 260. Accordingly, the excess pressure applied to the printing head 21 from the supply channel 200 is released to the outside through the relief channel 260, the buffer tank 108, and the air communicating port 109.

In the collecting channel 300, the third conduit section 107, the third pump 103, and the check valve 131 are disposed in this order from the printing head 21 side. The cross-section area of the internal space of the third conduit section 107 is larger than the cross-section area of the collecting channel 300. This allows the third conduit section 107 to reduce pulsation of ink discharged from the printing head 21.

The third pump 103 sends the ink discharged from the printing head 21 to the buffer tank 108 through the third conduit section 107 disposed in the collecting channel 300. The third pump 103 is configured using a diaphragm pump, for example.

The check valve 131 restricts the flow of ink from the buffer tank 108 toward the printing head 21, while allowing ink to flow from the printing head 21 toward the buffer tank 108. This allows the check valve 131 to suppress ink backflow in the collecting channel 300 as the ink is filled in the printing head 21 and the circulation liquid channel. Therefore, if the negative pressure applied to the printing head 21 and the circulation liquid channel through the cap 161 becomes too strong as the ink is filled in the printing head 21 and the circulation liquid channel, the ink can be suppressed from flowing into the printing head 21 from the collecting channel 300. A flow rate sensor 136 is also disposed between the check valve 131 and the buffer tank 108 in the collecting channel 300.

The flow rate sensor 136 is a sensor for monitoring the flow rate of ink flowing through the collecting channel 300 (circulation liquid channel) by the circulation control unit 505 as the ink circulates through the circulation liquid channel. The circulation control unit 505 performs control to change a drive frequency of the third pump 103 by sending a control signal to the third pump 103, so that the flow rate value detected by the flow rate sensor 136 falls within a predetermined flow rate range. If the flow rate value detected by the flow rate sensor 136 falls outside the predetermined flow rate range even after the drive frequency is changed, the circulation control unit 505 detects an abnormality in the collecting channel 300 and controls the circulation unit 100 to stop circulating the ink.

The collection-side air communicating channel 350 is a channel for releasing the pressure inside the collecting channel 300 to atmospheric pressure as the ink circulation stops. The collection-side air communicating channel 350 branches off from a portion of the collecting channel 300 between the printing head 21 and the third conduit section 107, and is connected to the buffer tank 108. The second solenoid valve 132 is disposed in the collection-side air communicating channel 350. The pressure inside the collecting channel 300 is released to the atmospheric pressure through the collection-side air communicating channel 350, the buffer tank 108, and the air communicating port 109 by the second solenoid valve 132 opening the collection-side air communicating channel 350 as the ink circulation stops.

The configuration of the circulation unit 100 is not limited to that described in the present embodiment. For example, the circulation unit 100 does not have to have a filter or a check valve. Furthermore, the circulation unit 100 does not have to have a temperature sensor.

The recovery unit 160 includes the cap 161, a suction pump 162, a suction pipe 163, a waste liquid tank 164, and a suction solenoid valve 165. The cap 161 caps (covers) an ejection surface 26 formed in the lower part of the printing head 21 in a state where the printing head 21 is located in the maintenance position. The ejection surface 26 of the printing head 21 has a plurality of ejection ports (not shown) formed therein for ejecting ink from the printing head 21. The suction pump 162 sucks ink inside the cap 161 through the suction pipe 163 and the waste liquid tank 164. The suction pipe 163 connects the cap 161 to the waste liquid tank 164. The waste liquid tank 164 stores waste ink sucked by the suction pump 162. The suction solenoid valve 165 is disposed in the suction pipe 163 and capable of opening and closing the flow path inside the suction pipe 163. For example, with the cap 161 capping the ejection surface 26 of the printing head 21, the suction solenoid valve 165 opens the flow path inside the suction pipe 163, causing the suction pump 162 to suck the inside of the printing head 21 through the cap 161. This makes it possible to remove air bubbles remaining inside the printing head 21 and ink with increased viscosity near the ejection ports of the printing head 21. The recovery unit 160 also functions as a negative pressure imparting unit configured to impart negative pressure in the circulation liquid channel through the printing head 21 as the ink is filled in the printing head 21 and the circulation liquid channel.

### <Liquid Circulation Path Inside Printing Head>

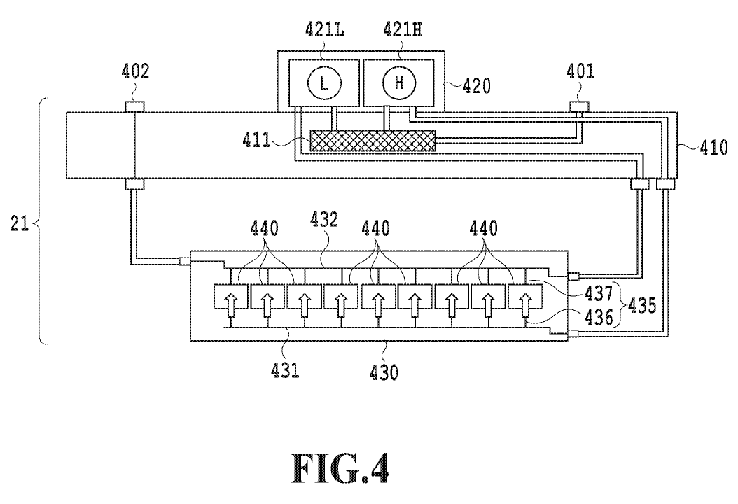

FIG. 4 is a schematic diagram showing the liquid circulation path inside the printing head 21 in the present embodiment. The printing head 21 includes a liquid supply unit 410, a negative pressure control unit 420, and a liquid ejection unit 430, all of which are provided inside the printing head 21. The liquid supply unit 410 is connected to the supply channel 200 through a supply-side connection part 401. The liquid supply unit 410 is also connected to the liquid ejection unit 430 through the negative pressure control unit 420. The liquid ejection unit 430 is connected to the collecting channel 300 through a collection-side connection part 402.

The ink stored in the buffer tank 108 of the circulation unit 100 is supplied from the supply channel 200 to the liquid supply unit 410 of the printing head 21 through the supply-side connection part 401 by the first pump 101 and the second pump 102. After being supplied to the liquid supply unit 410, the ink is adjusted to two different negative pressures (high pressure and low pressure) by the negative pressure control unit 420. The ink then splits into two flow paths, high-pressure side and low-pressure side, and reaches the liquid ejection unit 430. The ink supplied to the inside of the printing head 21 is circulated inside the printing head 21 through the liquid supply unit 410, the negative pressure control unit 420, and the liquid ejection unit 430 by the third pump 103 of the circulation unit 100. The ink circulated inside the printing head 21 is discharged from the liquid ejection unit 430 to the collecting channel 300 through the collection-side connection part 402, and is collected in the buffer tank 108. In this case, the third pump 103 draws the ink inside the printing head 21 from the collection-side connection part 402 and sends the ink to the buffer tank 108.

As described above, the first pump 101 and the second pump 102 are configured using diaphragm pumps, for example. The first pump 101 and the second pump 102 may be any pump with a head pressure greater than or equal to a given pressure within the range of the ink circulation flow rate used as the printing head 21 is operated. The first pump 101 and the second pump 102 may be a turbo pump, a positive-displacement pump, or the like. For example, instead of the diaphragm pumps, a head tank disposed with a certain water head difference relative to the negative pressure control unit 420 may be used as the first pump 101 and the second pump 102.

As described above, the third pump 103 is configured using a diaphragm pump, for example. It is preferable to use a positive-displacement pump with a quantitative liquid feeding capacity as the third pump 103. The third pump 103 may also be configured to ensure a constant flow rate by having a general constant flow rate valve or relief valve at the pump outlet. As the printing head 21 is operated, the third pump 103 is operated to cause the ink to flow at a predetermined flow rate through a common supply channel 431 and a common collecting channel 432 of the liquid ejection unit 430. Such an ink flow at the predetermined flow rate allows the temperature inside the printing head 21 to be maintained at an optimum temperature. The predetermined flow rate of the ink is preferably set to be higher than or equal to a flow rate at which a temperature difference between a plurality of printing element substrates 440 in the liquid ejection unit 430 does not affect image quality. However, if the predetermined ink flow rate is too high, the negative pressure difference between the plurality of printing element substrates 440 is increased by the influence of pressure loss in the flow path inside the liquid ejection unit 430, resulting in uneven density in an image printed using the plurality of printing element substrates 440. For this reason, it is preferable to set the predetermined flow rate of ink, taking into consideration the temperature difference and negative pressure difference between the plurality of printing element substrates 440.

The negative pressure control unit 420 is disposed in a flow path between the first and second conduit sections 105 and 106 of the circulation unit 100 and the liquid ejection unit 430. The flow rate of the ink circulating inside the printing head 21 can fluctuate due to a difference in ejection volume per unit area. Even if the flow rate of ink circulating inside the printing head 21 fluctuates, the negative pressure control unit 420 operates to maintain the pressure in the flow path downstream of the negative pressure control unit 420 (on the liquid ejection unit 430 side) at a preset constant pressure. The negative pressure control unit 420 has two pressure regulating mechanisms 421H and 421L on the high-pressure side (H) and on the low-pressure side (L). The two pressure regulating mechanisms 421H and 421L may be any mechanism capable of controlling the pressure in the flow path downstream of the negative pressure control unit 420 within a given range of fluctuations centered on a desired set pressure. The two pressure regulating mechanisms 421H and 421L may be, for example, mechanisms similar to so-called “pressure-reducing regulators”. In the present embodiment, the first pump 101 and the second pump 102 pressurize the upstream side of the negative pressure control unit 420 through the liquid supply unit 410. This makes it possible to reduce the influence of the water head difference in the buffer tank 108 on the printing head 21, thereby increasing the degree of freedom of layout of the buffer tank 108 in the printing apparatus.

The two pressure regulating mechanisms 421H and 421L are set to have different control pressures. The control pressure of the high-pressure side (H) pressure regulating mechanism 421H is set to a relatively high pressure. The control pressure of the low-pressure side (L) pressure regulating mechanism 421L is set to a relatively low pressure. The upstream side of the two pressure regulating mechanisms 421H and 421L is connected to a flow path from the supply-side connection part 401 through a filter 411 provided in the liquid supply unit 410. The downstream side of the high-pressure side (H) pressure regulating mechanism 421H is connected to the common supply channel 431 of the liquid ejection unit 430 through the inside of the liquid supply unit 410. The downstream side of the low-pressure side (L) pressure regulating mechanism 421L is connected to the common collecting channel 432 of the liquid ejection unit 430 through the inside of the liquid supply unit 410.

The liquid ejection unit 430 has the common supply channel 431, the common collecting channel 432, a plurality of individual channels 435, and the plurality of printing element substrates 440. The plurality of individual channels 435 are provided corresponding to the plurality of printing element substrates 440. The plurality of individual channels 435 are communicated with the common supply channel 431 and the common collecting channel 432. Each of the printing element substrates 440 is disposed in each of the individual channels 435. The individual channel 435 has an individual supply channel 436 and an individual collecting channel 437. The individual supply channel 436 is communicated with the common supply channel 431 and the printing element substrate 440. The individual collecting channel 437 is communicated with the printing element substrate 440 and the common collecting channel 432. The downstream side of the common collecting channel 432 is connected to the collecting channel 300 through the collection-side connection part 402. The printing element substrate 440 has a pressure chamber (not shown), a printing element (not shown), and the like for ejecting ink from an ejection port (not shown).

The high-pressure side (H) pressure regulating mechanism 421H is connected to the common supply channel 431, and the low-pressure side (L) pressure regulating mechanism 421L is connected to the common collecting channel 432, creating a negative pressure difference (pressure difference) between the common supply channel 431 and the common collecting channel 432. The negative pressure difference between the common supply channel 431 and the common collecting channel 432 causes some of the ink flowing through the common supply channel 431 to pass through the individual supply channels 436 in the individual channels 435, the internal channels of the printing element substrates 440, and the individual collecting channels 437, and then flow into the common collecting channel 432.

In the liquid ejection unit 430, while ink from the negative pressure control unit 420 flows through the common supply channel 431 and the common collecting channel 432, some of the ink flowing through the common supply channel 431 passes through the internal channels of the printing element substrates 440. Therefore, heat generated in each printing element substrate 440 can be discharged to the outside of the printing head 21 (liquid ejection unit 430) by the ink flowing through the common supply channel 431 and the common collecting channel 432. Furthermore, upon printing of an image by the printing head 21, ink also flows through the ejection ports and pressure chambers of the printing element substrates 440 that do not eject ink. This makes it possible to reduce the ink viscosity increased inside the ejection ports, thus avoiding a situation where the ink cannot be normally ejected due to the increased viscosity near the ejection ports. Furthermore, ink with increased viscosity or foreign matter contained in the ink can be discharged from the printing element substrates 440 to the common collecting channel 432. This enables the printing head 21 of the present embodiment to print high-quality images at high speed.

### < Configuration of Control Unit>

FIG. 5 is a block diagram showing a control unit 500 of the printing apparatus 10. The control unit 500 includes a printer control unit 501, a communication unit 502, an operation control unit 503, a printing medium conveyance control unit 504, and a circulation control unit 505. The printer control unit 501 controls a printing process. The printer control unit 501 includes a central processing unit (CPU) 511, a read-only memory (ROM) 512, a random access memory (RAM) 513, an application specific integrated circuit (ASIC) 514, and a head control unit 515.

The CPU 511 controls the entire printing apparatus 10. The ROM 512 stores control programs executed by the CPU 511 and various data. The RAM 513 temporarily stores data processed by the CPU 511 and data received by the communication unit 502. The ASIC 514 includes a network controller, a serial IF controller, a head data generation controller, a motor controller, and the like. The head control unit 515 generates final ejection data for ejecting ink from the printing head 21, generates a drive voltage, controls the elevation and lowering of the printing head holding portion 22, and obtains the temperature of the printing head 21. The CPU 511, the ROM 512, and the RAM 513 are electrically connected to the ASIC 514. The ASIC 514 is electrically connected to the head control unit 515.

The communication unit 502 receives a print job containing print data sent from an external print server or personal computer (PC). The operation control unit 503 controls an operation panel (not shown) for receiving user input. The printing medium conveyance control unit 504 controls the conveyance of the printing medium. The circulation control unit 505 controls the operations of the first to third pumps 101 to 103, the first solenoid valve 121, the second solenoid valve 132, and the like in the circulation unit 100. The operation control unit 503, the printing medium conveyance control unit 504, and the circulation control unit 505 each include at least one processor and at least one storage device for storing programs executed by the processor. A semiconductor memory, for example, is used as the storage device. The communication unit 502, the operation control unit 503, the printing medium conveyance control unit 504, and the circulation control unit 505 are electrically connected to the ASIC 514 of the printer control unit 501.

### <Comparative Example>

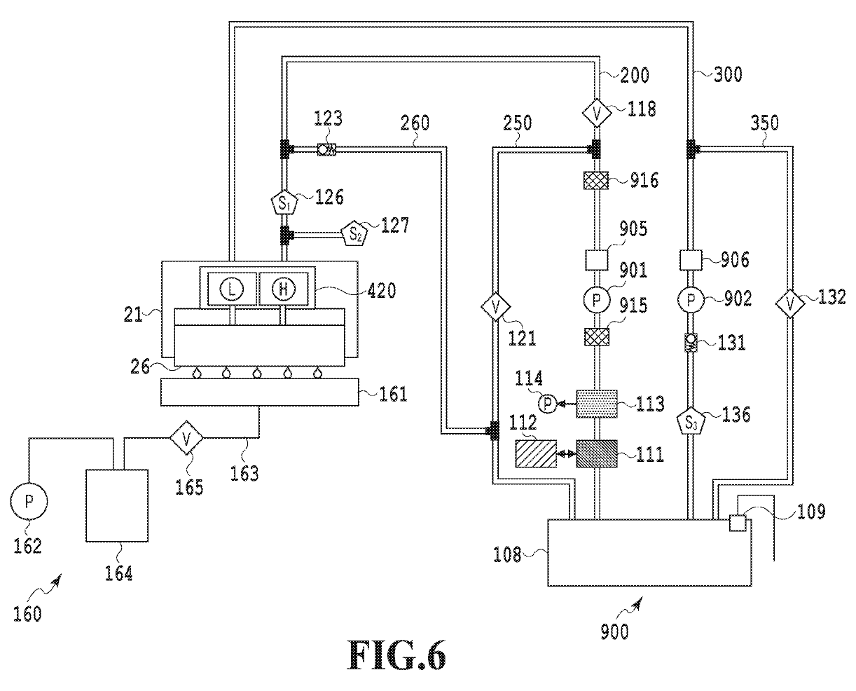

Next, a comparative example of the present embodiment will be described. FIG. 6 is a schematic diagram showing a comparative example of a circulation liquid channel including a circulation unit 900. As shown in FIG. 6, a supply channel 200 of the comparative example does not have a first branching flow passage 210 or a second branching flow passage 220. In the supply channel 200 of the comparative example, a heat exchanger 111, a deaeration module 113, a first supply-side filter 915, a supply pump 901, a supply-side conduit section 905, a second supply-side filter 916, and a choke valve 118 are disposed in this order from the buffer tank 108 side. The first supply-side filter 915 has the same configuration as that of the first filter 115 of the present embodiment. The second supply-side filter 916 has the same configuration as that of the third filter 117 of the present embodiment. The supply pump 901 has the same configuration as that of the first pump 101 of the present embodiment. The supply-side conduit section 905 has the same configuration as that of the first conduit section 105 of the present embodiment.

In a collecting channel 300 of the comparative example, a collection-side conduit section 807, a collection pump 803, and a check valve 131 are disposed in this order from the printing head 21 side. The collection-side conduit section 807 has the same configuration as that of the third conduit section 107 of the present embodiment. The collection pump 803 has the same configuration as that of the third pump 103 of the present embodiment.

In the supply channel 200 consisting of only one channel, if a high-density filter is added, increasing pressure loss, it becomes necessary to increase the ink flow rate. Furthermore, in order to improve the printing speed, it may be necessary to increase the ink flow rate in the supply channel 200. One method of increasing the ink flow rate is, for example, to increase the output of the supply pump 901. As the output of the supply pump 901 increases, the size of the supply pump 901 also increases three-dimensionally. If the installation space for the pump is limited due to a reason such as the inability to change the spacing between the pump and adjacent components, it is difficult to increase the size of the supply pump 901. It is therefore difficult to increase the ink flow rate by increasing the output of the supply pump 901. For example, even if there is a space above and below the pump as well as in front of and behind the pump to accommodate a larger pump, it is difficult to increase the size of the pump if the spacing between the pump and adjacent components on the left and right of the pump cannot be changed.

Here, description will be given of a technique capable of increasing the flow rate of a liquid (ink) supplied to the printing head 21 while ensuring pump installation space. As described above, the first branching flow passage 210 and the second branching flow passage 220 are provided with the first pump 101 and the second pump 102. That is, pumps for sending ink to the printing head 21 are provided in a plurality of branching flow passages, respectively. This suppresses three-dimensional increase in size of the pumps in the plurality of branching flow passages, allowing the pumps (first pump 101 and second pump 102) to be arranged side by side along the direction in which the space capable of accommodating the pumps expands. This makes it possible to increase the flow rate of the ink supplied to the printing head 21 while ensuring the pump installation space.

On the downstream side of the supply channel 200, where a plurality of branching flow passages merge, ink flows at a higher speed and pressure than the ink flowing through the supply channel consisting of only one channel. For example, if the pump duty is 100%, providing a pump in each of the plurality of branching flow passages is more advantageous for increasing the ink flow rate than providing a pump in a supply channel consisting of only one channel. It is also conceivable to dispose a plurality of pumps in series in a supply channel consisting of only one channel. However, the sum of the cross-section areas of the plurality of branching flow passages is larger than the cross-section area of the supply channel consisting of only one channel. For this reason, providing a pump in each of the plurality of branching flow passages is more advantageous for increasing the ink flow rate than providing a plurality of pumps in the supply channel consisting of only one channel.

Furthermore, depending on the pump characteristics, the ink flow rate does not necessarily increase in proportion to an increase in pump duty. As the pump duty increases, the pump efficiency may decrease due to vibration or the like. For this reason, driving pumps installed in a plurality of branching flow passages at an efficient duty can increase the ink flow rate more efficiently than driving a pump installed in a supply channel consisting of only one channel at a high duty.

### <Ink Filling Operation>

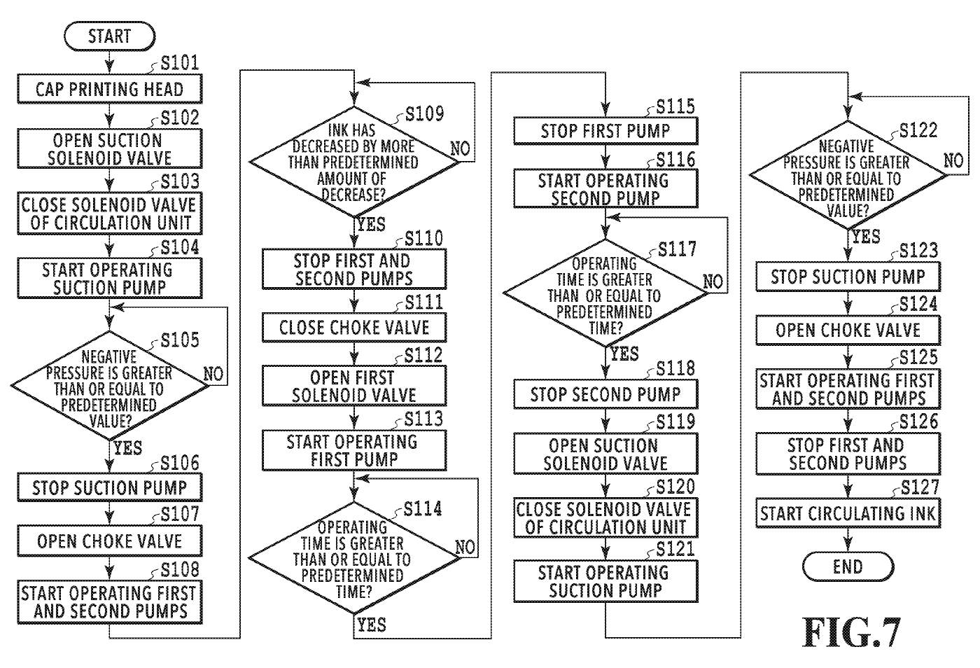

Next, description will be given of a filling operation for filling the printing head 21 and the circulation liquid channel with ink. FIG. 7 is a flowchart showing a flow of the ink filling operation. The ink filling operation is controlled by the printer control unit 501, the circulation control unit 505, and the like of the control unit 500. The ink filling operation is performed upon first ink filling (initial filling) of the printing head 21 and the circulation liquid channel. In addition to the initial filling, the ink filling operation may also be performed, for example, as the printing apparatus 10 is started for the first time in a day. The ink filling operation is performed in a case where ink circulation has not been performed for an extended period of time, and there is a possibility that many air bubbles are accumulated in the circulation liquid channel or that ink in the circulation liquid channel has fallen into the buffer tank 108. Note that the ink filling operation is not performed during normal ink circulation. The ink filling operation is not performed during a recovery operation.

First, in Step S101, the cap 161 of the recovery unit 160 caps the ejection surface 26 of the printing head 21. In this event, the printing head holding portion 22 and the like are operated to move the printing head 21 to the maintenance position above and near the cap 161.

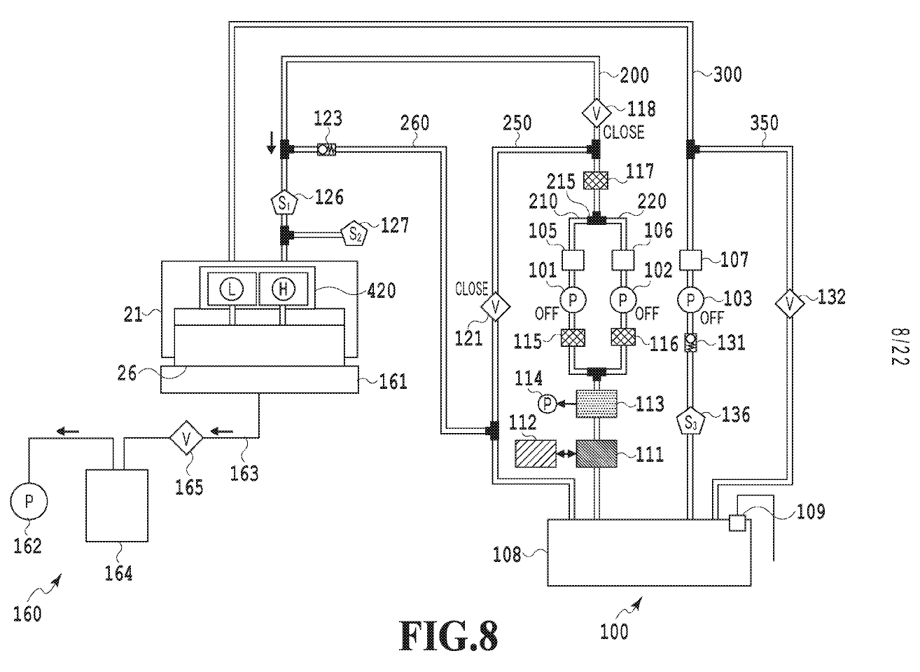

FIG. 8 is an explanatory diagram showing a state of the cap 161 capping the ejection surface 26 of the printing head 21. As shown in FIG. 8, as the printing head 21 moves to the maintenance position, the cap 161 caps the ejection surface 26 of the printing head 21. In this event, the printing head 21 may approach the cap 161 for capping, or the cap 161 may approach the printing head 21 for capping.

Referring back to FIG. 7, in the next Step S102, the suction solenoid valve 165 of the recovery unit 160 opens the flow path in the suction pipe 163. With the cap 161 capping the ejection surface 26 of the printing head 21, the suction solenoid valve 165 opens the flow path in the suction pipe 163, thereby allowing the recovery unit 160 to apply negative pressure to the circulation liquid channel through the printing head 21.

In Step S103, the choke valve 118 and the first solenoid valve 121 of the circulation unit 100 close a part of the circulation liquid channel. In this case, the choke valve 118 closes the supply channel 200 in the circulation liquid channel. The first solenoid valve 121 closes the supply-side air communicating channel 250. Note that the order of Steps S102 and S103 may be reversed. Steps S102 and S103 may be performed in parallel. Furthermore, the second solenoid valve 132 may close or open the collection-side air communicating channel 350.

In the next Step S104, the suction pump 162 of the recovery unit 160 starts its operation. With the flow path in the suction pipe 163 opened by the suction solenoid valve 165, the operation of the suction pump 162 causes negative pressure to act on the circulation liquid channel (supply channel 200) through the printing head 21. The magnitude of the negative pressure acting on the supply channel 200 is detected by the pressure sensor 127.

In the next Step S105, the circulation control unit 505 determines whether the magnitude (pressure value) of the negative pressure detected by the pressure sensor 127 is greater than or equal to a predetermined value. If the pressure value detected by the pressure sensor 127 is less than the predetermined value, that is, if the determination result in Step S105 is NO, the processing of Step S105 is repeated. If the pressure value detected by the pressure sensor 127 is greater than or equal to the predetermined value, that is, if the determination result in Step S105 is YES, the processing proceeds to Step S106. If Step S105 is executed a predetermined number of times, or if the determination result is NO even after a predetermined time has elapsed since the start of Step S104, the CPU 511 executes processing to notify the user of an error due to a problem with the ink supply. For example, the CPU 511 displays the error on the operation panel.

In Step S106, the suction pump 162 of the recovery unit 160 stops. In this event, with the supply channel 200 closed by the choke valve 118 of the circulation unit 100, negative pressure acts on the printing head 21 and the circulation liquid channel (supply channel 200).

In the next Step, S107, the choke valve 118 opens the supply channel 200. This allows ink to flow from the buffer tank 108 to the supply channel 200 by using the negative pressure applied to the supply channel 200 through the printing head 21.

In the next Step S108, the first pump 101 and the second pump 102 of the circulation unit 100 start their operation. With the choke valve 118 opened and the first solenoid valve 121 closed, the operation of the first pump 101 and the second pump 102 fills the supply channel 200 with the ink stored in the buffer tank 108. In addition, the weight of the buffer tank 108 in which the ink is stored is detected by a weight sensor (not shown).

The operations of Steps S101 to S108 are also referred to as choke suction. With no ink in the circulation liquid channel (supply channel 200), the first pump 101 and the second pump 102 have difficulty suctioning the ink, making it difficult to fill the printing head 21 and the circulation liquid channel with the ink. In the present embodiment, the recovery unit 160 applies negative pressure to the circulation liquid channel through the printing head 21, making it possible to improve the ability to fill the printing head 21 and the circulation liquid channel with the ink.

In the next Step, S109, the circulation control unit 505 determines whether the weight detected by the weight sensor has decreased by more than a predetermined amount of decrease. The amount of decrease in weight detected by the weight sensor corresponds to the amount of decrease in weight of the ink stored in the buffer tank 108. The predetermined amount of decrease is set to an ink filling amount (weight) in the supply channel 200 such that the first pump 101 and the second pump 102 are filled with the ink but the choke valve 118 is not filled with the ink. If the weight detected by the weight sensor has not decreased by more than the predetermined amount of decrease, that is, if the determination result in Step S109 is NO, the processing of Step S109 is repeated. If the weight detected by the weight sensor has decreased by more than the predetermined amount of decrease, that is, if the determination result in Step S109 is YES, the processing proceeds to Step S110. If Step S109 is executed a predetermined number of times, or if the determination result is NO even after a predetermined time has elapsed since the start of Step S108, the CPU 511 executes processing to notify the user of an error due to a problem with the ink supply. For example, the CPU 511 displays the error on the operation panel.

In Step S110, the first pump 101 and the second pump 102 of the circulation unit 100 stop. In this event, the pressure inside the supply channel 200 is released to atmospheric pressure.

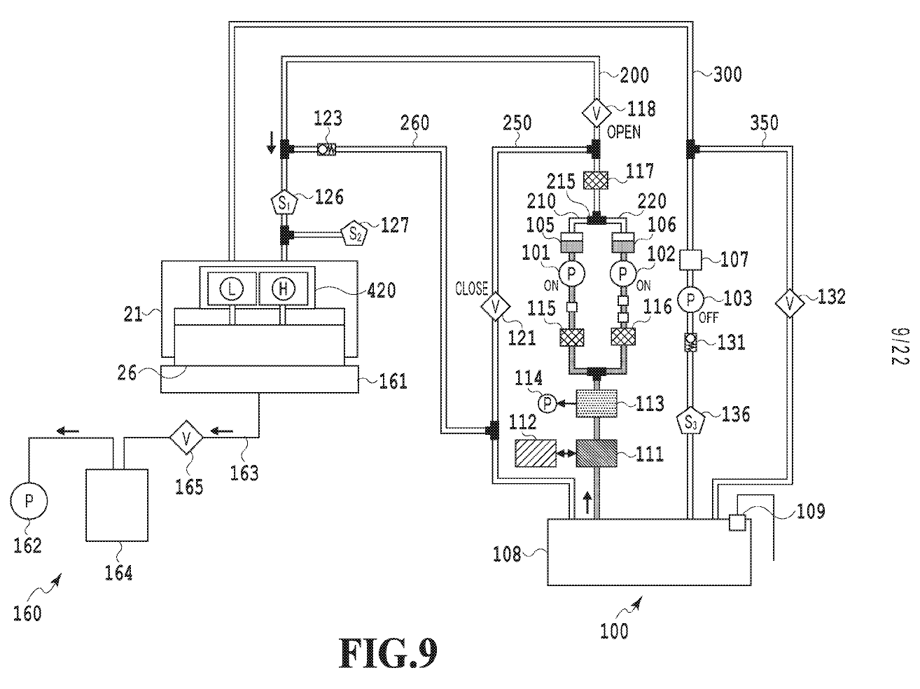

FIG. 9 is an explanatory diagram showing a state where the ink is filled up to the first pump 101 and the second pump 102. As shown in FIG. 9, the first choke suction fills the first pump 101 and the second pump 102 with the ink. If the first choke suction does not fill the first pump 101 and the second pump 102 with the ink, the first pump 101 and the second pump 102 will have difficulty suctioning the ink. This may cause the first pump 101 and the second pump 102 to take long to send the ink, or may cause the first pump 101 and the second pump 102 to be unable to send the ink.

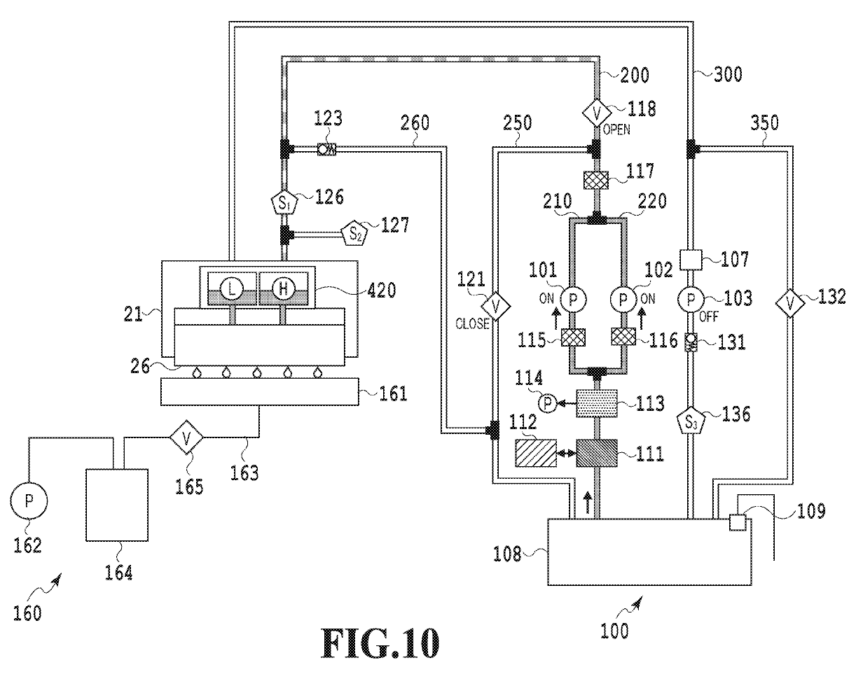

FIG. 10 is an explanatory diagram showing a state where the ink is filled up to a part of the supply channel 200 past the choke valve 118. It is preferable that the first choke suction fills the supply channel 200 with the ink up to just before the choke valve 118. As shown in FIG. 10, if the first conduit section 105 and the second conduit section 106 are not provided, the supply channel 200 is rapidly filled with the ink during the first choke suction, making it easier for the supply channel 200 to be filled with the ink up to the portion past the choke valve 118. As the ink is filled up to the portion of the supply channel 200 past the choke valve 118 by the first choke suction, the ink and gas are mixed in the portion of the supply channel 200 between the choke valve 118 and the printing head 21. If the ink filling operation is carried on with the ink and gas mixed in the supply channel 200, air bubbles may enter the negative pressure control unit 420 of the printing head 21. If air bubbles enter the negative pressure control unit 420, sticking matter is formed by the air bubbles entering the negative pressure control unit 420. The sticking matter formed in the negative pressure control unit 420 may affect image quality by entering the ejection ports (not shown) of the printing head 21. To avoid air bubbles from entering the negative pressure control unit 420, the ink filling amount in the first choke suction is set to a filling amount such that the first pump 101 and the second pump 102 are filled with the ink but the choke valve 118 is not filled with the ink.

In the first choke suction, the ink sent from the first pump 101 and the second pump 102 is filled in the internal spaces of the first conduit section 105 and the second conduit section 106, which are larger in cross-section area than the supply channel 200 (first branching flow passage 210 and second branching flow passage 220). This can suppress rapid ink filling in the supply channel 200, thus making it possible to avoid the supply channel 200 from being filled with the ink past the choke valve 118.

In the present embodiment, the ink filling amount in the first choke suction is managed based on, but not limited to, the amount of decrease in weight of the ink stored in the buffer tank 108. The ink filling amount in the first choke suction may also be managed based on the elapsed time since the start of the operation of the first pump 101 and the second pump 102.

Referring back to FIG. 7, in the next Step S111, the choke valve 118 of the circulation unit 100 closes the supply channel 200. As described above, it is preferable that the supply channel 200 be filled with the ink up to the portion just before the choke valve 118.

In the next Step S112, the first solenoid valve 121 of the circulation unit 100 opens the supply-side air communicating channel 250. This causes the downstream side of the first branching flow passage 210 and the second branching flow passage 220 to be communicated with the buffer tank 108 through the supply-side air communicating channel 250.

In the next Step S113, the first pump 101 of the circulation unit 100 starts its operation. In this case, out of the first pump 101 and the second pump 102 (and the third pump 103), only the first pump 101 starts its operation. With the choke valve 118 closed and the first solenoid valve 121 opened, the ink stored in the buffer tank 108 passes through the supply channel 200 (first branching flow passage 210) and the supply-side air communicating channel 250 before returning to the buffer tank 108. Therefore, the operation of the first pump 101 circulates the ink through the supply channel 200 (first branching flow passage 210), the supply-side air communicating channel 250, and the buffer tank 108.

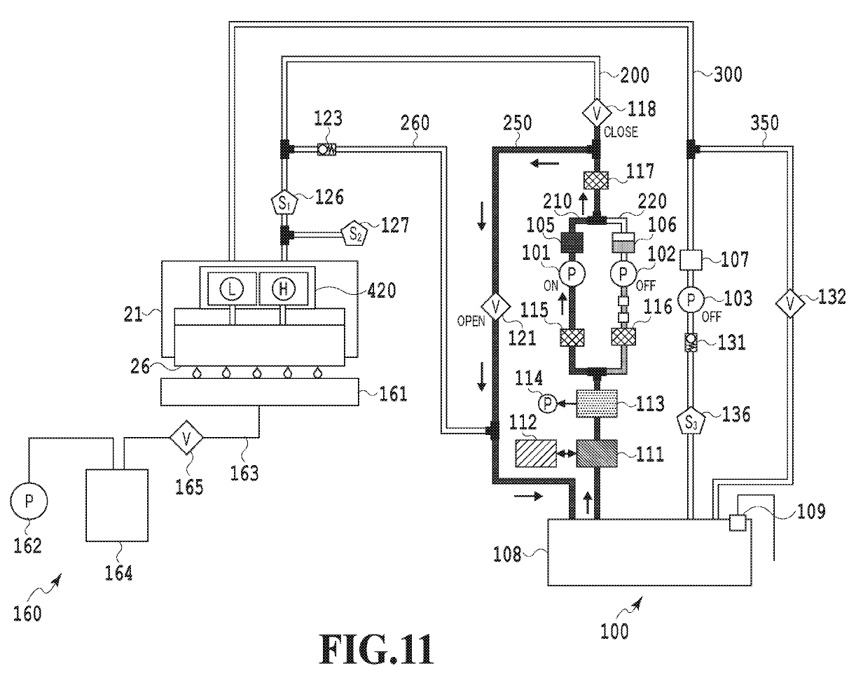

FIG. 11 is an explanatory diagram showing a state where, out of the first pump 101 and the second pump 102, only the first pump 101 is in operation. As shown in FIG. 11, with only the first pump 101 in operation, no ink flows through the second branching flow passage 220, where the second pump 102 is not in operation. As a result, air bubbles present in the first branching flow passage 210, where the first pump 101 is in operation, are discharged to the buffer tank 108 through the first branching flow passage 210 and the supply-side air communicating channel 250.

Referring back to FIG. 7, in the next Step S114, the circulation control unit 505 determines whether the operating time of the first pump 101 is greater than or equal to a predetermined time. If the operating time of the first pump 101 is less than the predetermined time, that is, if the determination result in Step S114 is NO, the processing of Step S114 is repeated. If the operating time of the first pump 101 is greater than or equal to the predetermined time, that is, if the determination result in Step S114 is YES, the processing proceeds to Step S115.

In Step S115, the first pump 101 of the circulation unit 100 stops. This stops the ink circulation by the first pump 101.

In the next Step S116, the second pump 102 of the circulation unit 100 starts its operation. In this case, out of the first pump 101 and the second pump 102 (and the third pump 103), only the second pump 102 starts its operation. With the choke valve 118 closed and the first solenoid valve 121 opened, the ink stored in the buffer tank 108 passes through the supply channel 200 (second branching flow passage 220) and the supply-side air communicating channel 250 before returning to the buffer tank 108. Therefore, the operation of the second pump 102 circulates the ink through the supply channel 200 (second branching flow passage 220), the supply-side air communicating channel 250, and the buffer tank 108.

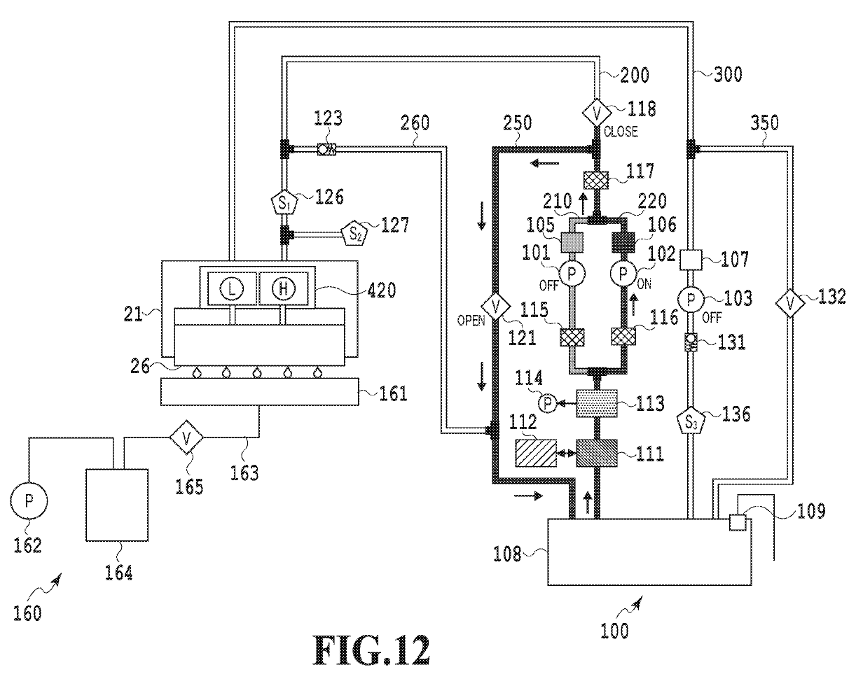

FIG. 12 is an explanatory diagram showing a state where, out of the first pump 101 and the second pump 102, only the second pump 102 is in operation. As shown in FIG. 12, with only the second pump 102 in operation, no ink flows through the first branching flow passage 210, where the first pump 101 is not in operation. As a result, air bubbles present in the second branching flow passage 220, where the second pump 102 is in operation, are discharged to the buffer tank 108 through the second branching flow passage 220 and the supply-side air communicating channel 250. The operation of the first pump 101 or the second pump 102 circulates the ink through the supply channel 200, the supply-side air communicating channel 250, and the buffer tank 108, thereby filling the supply channel 200 with the ink up to the supply-side air communicating channel 250. Furthermore, by alternately operating the first pump 101 and the second pump 102 to circulate the ink, air bubbles present in the supply channel 200 up to the portion just before the choke valve 118 can be discharged to the buffer tank 108 through the supply-side air communicating channel 250.

Referring back to FIG. 7, in the next Step S117, the circulation control unit 505 determines whether the operating time of the second pump 102 is greater than or equal to a predetermined time. If the operating time of the second pump 102 is less than the predetermined time, that is, if the determination result in Step S117 is NO, the processing of Step S117 is repeated. If the operating time of the second pump 102 is greater than or equal to the predetermined time, that is, if the determination result in Step S117 is YES, the processing proceeds to Step S118.

In Step S118, the second pump 102 of the circulation unit 100 stops. This stops the ink circulation by the second pump 102. Note that the operation of only the first pump 101 is performed first in the present embodiment, but the operation of only the second pump 102 may be performed first.

In Step S119, the suction solenoid valve 165 of the recovery unit 160 opens the flow path in the suction pipe 163. With the cap 161 capping the ejection surface 26 of the printing head 21, the suction solenoid valve 165 opens the flow path in the suction pipe 163, allowing the recovery unit 160 to apply negative pressure to the circulation liquid channel through the printing head 21.

In Step S120, the choke valve 118 and the first solenoid valve 121 of the circulation unit 100 close a part of the circulation liquid channel. In this event, the choke valve 118 closes the supply channel 200 filled with ink up to just before the choke valve 118. The first solenoid valve 121 closes the supply-side air communicating channel 250 filled with ink. Note that the order of Steps S119 and S120 may be reversed. Steps S119 and S120 may be performed in parallel. Furthermore, the second solenoid valve 132 may close or open the collection-side air communicating channel 350.

In the next Step S121, the suction pump 162 of the recovery unit 160 starts its operation. With the flow path in the suction pipe 163 opened by the suction solenoid valve 165, the operation of the suction pump 162 causes negative pressure to act on the circulation liquid channel (supply channel 200) through the printing head 21. The magnitude of the negative pressure acting on the supply channel 200 is detected by the pressure sensor 127.

In the next Step S122, the circulation control unit 505 determines whether the magnitude (pressure value) of the negative pressure detected by the pressure sensor 127 is greater than or equal to a predetermined value. If the pressure value detected by the pressure sensor 127 is less than the predetermined value, that is, if the determination result in Step S122 is NO, the processing of Step S122 is repeated. If the pressure value detected by the pressure sensor 127 is greater than or equal to the predetermined value, that is, if the determination result in Step S122 is YES, the processing proceeds to Step S123. If Step S122 is executed a predetermined number of times, or if the determination result is NO even after a predetermined time has elapsed since the start of Step S121, the CPU 511 executes processing to notify the user of an error due to a problem with the ink supply. For example, the CPU 511 displays the error on the operation panel.

In Step S123, the suction pump 162 of the recovery unit 160 stops. In this event, with the supply channel 200 closed by the choke valve 118 of the circulation unit 100, negative pressure acts on the printing head 21 and the circulation liquid channel (supply channel 200).

In the next Step S124, the choke valve 118 opens the supply channel 200. This allows ink to flow into the portion of the supply channel 200 downstream of the choke valve 118 by using the negative pressure applied to the supply channel 200 through the printing head 21.

In the next Step S125, the first pump 101 and the second pump 102 of the circulation unit 100 start their operation. With the choke valve 118 opened and the first solenoid valve 121 closed, the operation of the first pump 101 and the second pump 102 fills the supply channel 200 and the printing head 21 with the ink stored in the buffer tank 108.

In the next Step S126, the first pump 101 and the second pump 102 of the circulation unit 100 stop. The operations of Steps S119 to S126 are also referred to as second choke suction. The ink filling amount in the second choke suction may be managed based on the amount of decrease in weight of the ink stored in the buffer tank 108. The ink filling amount in the second choke suction may also be managed based on the elapsed time since the start of the operation of the first pump 101 and the second pump 102.

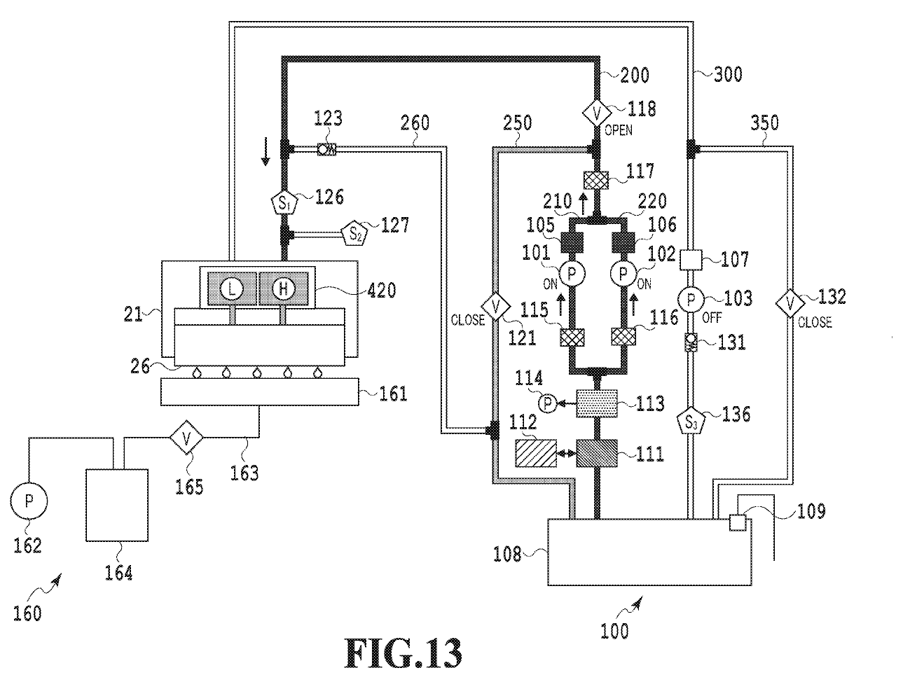

FIG. 13 is an explanatory diagram showing a state where the supply channel 200 and the printing head 21 are filled with ink. As the second choke suction is performed with the supply channel 200 filled with ink up to just before the choke valve 118, gas (air) remaining in the supply channel 200 is first discharged. Next, as shown in FIG. 13, the ink in the supply channel 200 is discharged from the choke valve 118 to the cap 161 of the recovery unit 160 through the downstream side of the supply channel 200 and the inside of the printing head 21. This makes it possible to suppress air bubbles from entering the negative pressure control unit 420 of the printing head 21 during the ink filling operation.

Then, in Step S127, the first pump 101, the second pump 102, and the third pump 103 of the circulation unit 100 start their operation. In this event, the choke valve 118 opens the supply channel 200. The first solenoid valve 121 closes the supply-side air communicating channel 250. The second solenoid valve 132 closes the collection-side air communicating channel 350. Through the operation of the first pump 101, the second pump 102, and the third pump 103, the ink is also filled in the collecting channel 300 through the supply channel 200 and the printing head 21. The ink filling operation is thus completed, and ink circulation starts in the circulation liquid channel.

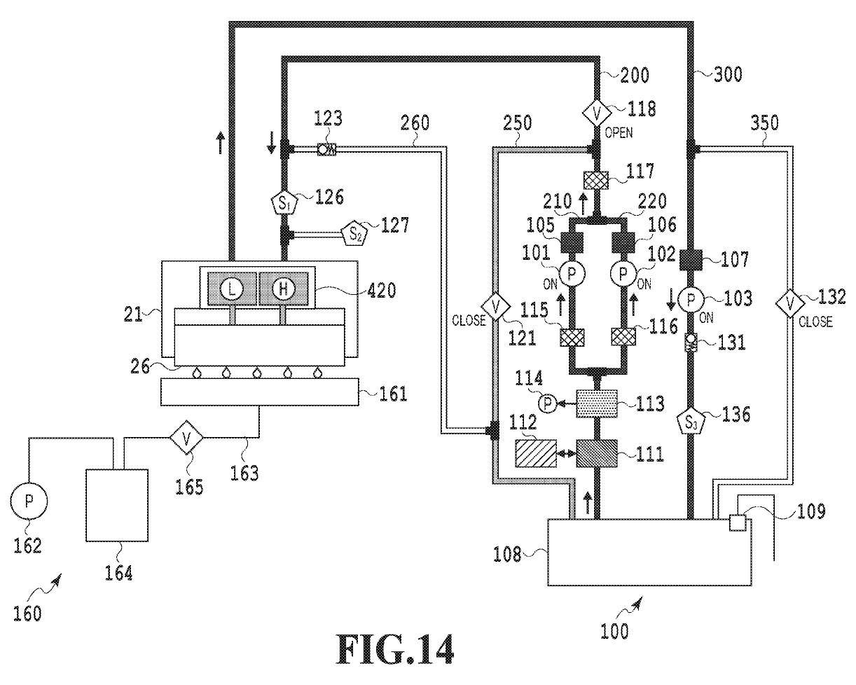

FIG. 14 is an explanatory diagram showing a state where ink is filled in the collecting channel 300, in addition to the supply channel 200 and the printing head 21. As shown in FIG. 14, the first pump 101 and the second pump 102 provided in the first branching flow passage 210 and the second branching flow passage 220 supply ink to the printing head 21 at a higher flow rate than a pump provided in a supply channel consisting of only one channel.

Furthermore, the first to third conduit sections 105 to 107 are arranged along a direction in which the ink flows from the lower side to the upper side in the vertical direction. This suppresses generation of relatively large air bubbles inside the first to third conduit sections 105 to 107, thus making it possible to suppress air bubbles from entering the inside (negative pressure control unit 420) of the printing head 21. The first to third conduit sections 105 to 107 are also larger in cross-section area than the supply channel 200 and the collecting channel 300. This can reduce pulsation generated as the first pump 101 and the second pump 102 send the ink, as well as pulsation of ink discharged from the printing head 21. Furthermore, even if the ink and the gas mix in the supply channel 200 during the ink filling operation, air bubbles can be contained inside the first conduit section 105 and the second conduit section 106, thus suppressing the air bubbles from entering the inside of the printing head 21.

### <Deaeration Operation>

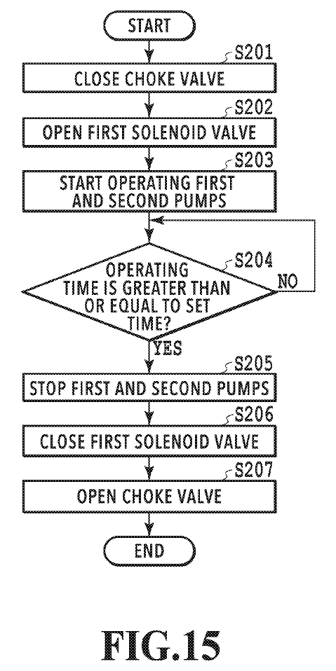

Next, description will be given of a deaeration operation to remove air bubbles from the supply channel 200. FIG. 15 is a flowchart showing a flow of the deaeration operation. The deaeration operation is controlled by the printer control unit 501, the circulation control unit 505, and the like of the control unit 500. The deaeration operation may be performed, for example, before the first pump 101, the second pump 102, and the third pump 103 start their operation after the second choke suction during the ink filling operation. The deaeration operation may also be performed every predetermined elapsed time (for example, two hours) after the ink filling operation.

First, in Step S201, the choke valve 118 of the circulation unit 100 closes the supply channel 200.

In the next Step S202, the first solenoid valve 121 of the circulation unit 100 opens the supply-side air communicating channel 250. As a result, the downstream side of the first branching flow passage 210 and the second branching flow passage 220 is communicated with the buffer tank 108 through the supply-side air communicating channel 250. The order of Steps S201 and S202 may be reversed. Steps S201 and S202 may be performed in parallel.

In the next Step S203, the first pump 101 and the second pump 102 of the circulation unit 100 start their operation. With the choke valve 118 closed and the first solenoid valve 121 opened, the ink stored in the buffer tank 108 passes through the first branching flow passage 210 or the second branching flow passage 220 before returning to the buffer tank 108 through the supply-side air communicating channel 250. Therefore, the operation of the first pump 101 and the second pump 102 circulates the ink through the supply channel 200 (first branching flow passage 210 and second branching flow passage 220), the supply-side air communicating channel 250, and the buffer tank 108.

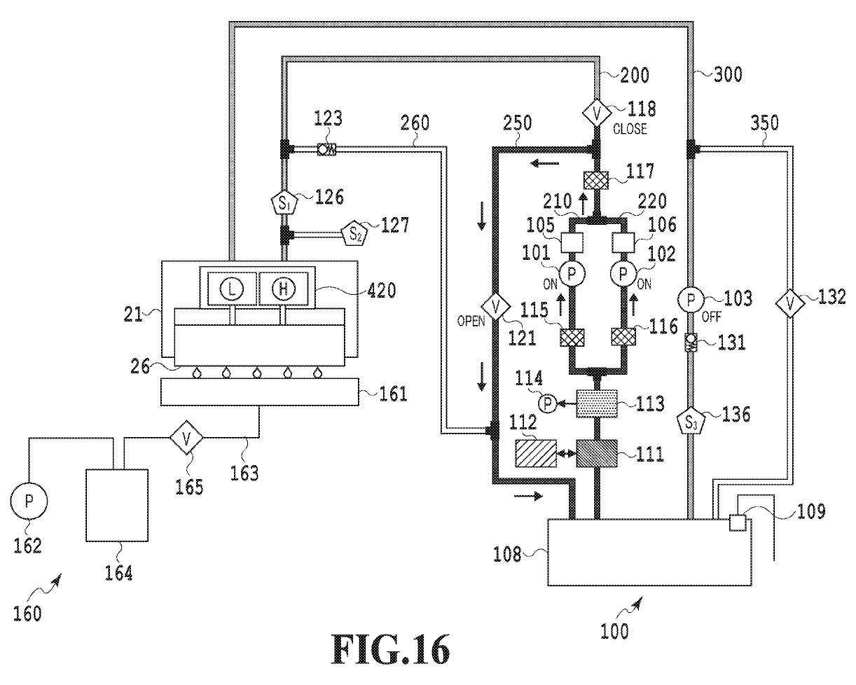

FIG. 16 is an explanatory diagram showing a state where the first pump 101 and the second pump 102 are in operation during the deaeration operation. As shown in FIG. 16, air bubbles present in the first branching flow passage 210, where the first pump 101 is in operation, are discharged to the buffer tank 108 through the first branching flow passage 210 and the supply-side air communicating channel 250. Similarly, air bubbles present in the second branching flow passage 220, where the second pump 102 is in operation, are discharged to the buffer tank 108 through the second branching flow passage 220 and the supply-side air communicating channel 250.

Referring back to FIG. 15, in the next Step S204, the circulation control unit 505 determines whether the operating time of the first pump 101 and the second pump 102 is greater than or equal to a predetermined set time. If the operating time of the first pump 101 and the second pump 102 is less than the set time, that is, if the determination result in Step S204 is NO, the processing of Step S204 is repeated. If the operating time of the first pump 101 and the second pump 102 is greater than or equal to the set time, that is, if the determination result in Step S204 is YES, the processing proceeds to Step S205.

In Step S205, the first pump 101 and the second pump 102 of the circulation unit 100 stop. This stops the ink circulation by the first pump 101 and the second pump 102.

In the next Step S206, the first solenoid valve 121 of the circulation unit 100 closes the supply-side air communicating channel 250.

Then, in Step S207, the choke valve 118 of the circulation unit 100 opens the supply channel 200. The deaeration operation is thus completed. Note that the order of Steps S206 and S207 may be reversed. Steps S206 and S207 may also be performed in parallel.

As described above, according to the first embodiment, the flow rate of ink (liquid) supplied to the printing head 21 can be increased while ensuring the pump installation space. For example, in the present embodiment, the pumps (first pump 101 and second pump 102) for sending ink to the printing head 21 are provided in each of the plurality of branching flow passages (first branching flow passage 210 and second branching flow passage 220). This allows the pumps (first pump 101 and second pump 102) to be arranged side by side along the direction in which the space capable of accommodating the pumps expands. This makes it possible to increase the flow rate of the ink supplied to the printing head 21 while ensuring the pump installation space.

If the first pump 101 and the second pump 102 are operated simultaneously after the first choke suction, ink flows only through the branching flow passage that was filled with the ink first, out of the two branching flow passages. This may result in the other branching flow passage not being filled with the ink. This leads to a possibility that it takes time to send the ink to the printing head 21, or that no ink can be sent to the printing head 21. As described above, after the first choke suction, the control unit 500 controls any one of the plurality of pumps to operate with the supply channel 200 closed by the choke valve 118 and the supply-side air communicating channel 250 opened by the first solenoid valve 121. The control unit 500 then performs control to operate one of the plurality of pumps (first pump 101 and second pump 102) for all of the plurality of pumps. Once the ink filling operation is completed, the control unit 500 controls the choke valve 118 to open the supply channel 200 and the first solenoid valve 121 to close the supply-side air communicating channel 250. This allows ink to flow through each of the plurality of branching flow passages (first branching flow passage 210 and second branching flow passage 220), making it possible to fill each of the plurality of branching flow passages with ink.

If air bubbles enter the negative pressure control unit 420 of the printing head 21, the air bubbles entering the negative pressure control unit 420 form sticking matter. The sticking matter formed in the negative pressure control unit 420 may affect image quality by entering the ejection ports (not shown) of the printing head 21. As described above, during the deaeration operation, the control unit 500 performs control to operate all of the plurality of pumps with the supply channel 200 closed by the choke valve 118 and the supply-side air communicating channel 250 opened by the first solenoid valve 121. Once the deaeration operation is completed, the control unit 500 controls the choke valve 118 to open the supply channel 200 and the first solenoid valve 121 to close the supply-side air communicating channel 250. As a result, air bubbles present in the first branching flow passage 210, where the first pump 101 is in operation, are discharged to the buffer tank 108 through the first branching flow passage 210 and the supply-side air communicating channel 250. Similarly, air bubbles present in the second branching flow passage 220, where the second pump 102 is in operation, are discharged to the buffer tank 108 through the second branching flow passage 220 and the supply-side air communicating channel 250. This makes it possible to remove the air bubbles present in the first branching flow passage 210 or the second branching flow passage 220, thus suppressing air bubbles from entering the inside (negative pressure control unit 420) of the printing head 21.

In the first embodiment described above, the first to third conduit sections 105 to 107 are disposed, but not limited to, along the direction in which ink flows from the lower side to the upper side in the vertical direction. For example, the first to third conduit sections 105 to 107 may also be disposed along the direction in which ink flows from the lower side to the upper side in a direction tilted relative to the vertical direction.

### <<SECOND EMBODIMENT>>

Next, a second embodiment of a printing apparatus will be described. Since individual members in the second embodiment are the same as those in the first embodiment described above, and will therefore be denoted by the same reference numerals as those in the first embodiment.

### <Configuration of Circulation Unit>

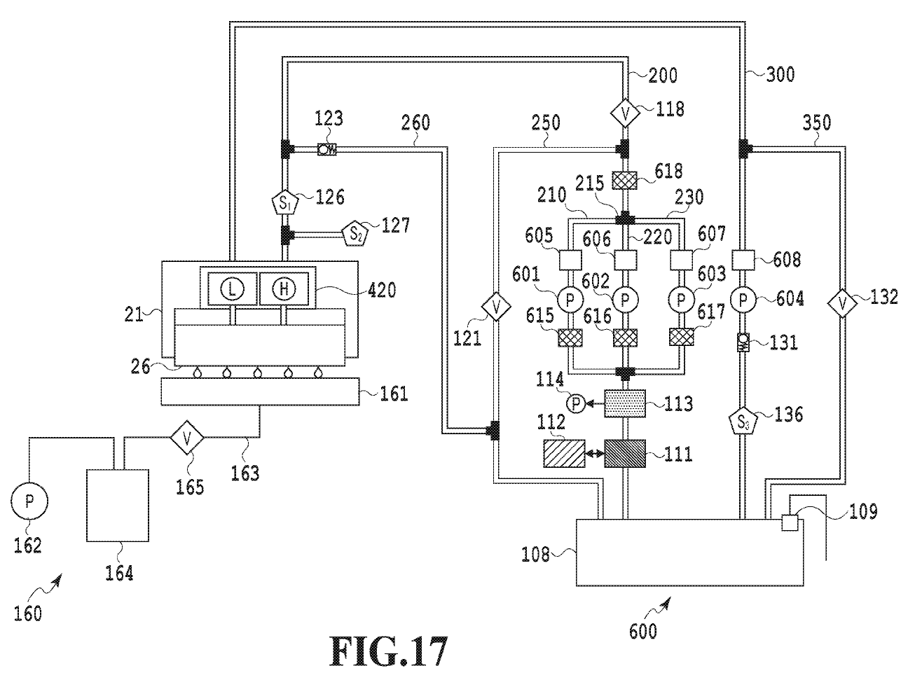

FIG. 17 is a schematic diagram showing a circulation liquid channel including a circulation unit 600 of the second embodiment. The circulation unit 600 of the second embodiment includes a first pump 601, a second pump 602, a third pump 603, a fourth pump 604, a first conduit section 605, a second conduit section 606, a third conduit section 607, a fourth conduit section 608, and a buffer tank 108. The circulation unit 600 also includes a heat exchanger 111, a deaeration module 113, a first filter 615, a second filter 616, a third filter 617, a fourth filter 618, and a choke valve 118. The circulation unit 600 also includes a first solenoid valve 121, a relief valve 123, a check valve 131, and a second solenoid valve 132. The components of the circulation unit 600 may be connected directly or through resin or metal piping. The first solenoid valve 121, the relief valve 123, the check valve 131, and the second solenoid valve 132 have the same configurations as those of the first solenoid valve 121, the relief valve 123, the check valve 131, and the second solenoid valve 132 of the first embodiment.

The buffer tank 108 has the same configuration as that of the buffer tank 108 of the first embodiment. As in the first embodiment, a supply channel 200, a supply-side air communicating channel 250, a relief channel 260, a collecting channel 300, and a collection-side air communicating channel 350 are connected to the buffer tank 108. The supply channel 200, the supply-side air communicating channel 250, the relief channel 260, the collecting channel 300, and the collection-side air communicating channel 350 form a circulation liquid channel for supplying and circulating ink to the printing head 21.

In the second embodiment, a first branching flow passage 210, a second branching flow passage 220, and a third branching flow passage 230 are formed in part of the supply channel 200 and configured to branch off and merge midway through the supply channel 200. In the supply channel 200, the heat exchanger 111, the deaeration module 113, the first branching flow passage 210, the second branching flow passage 220, the third branching flow passage 230, the fourth filter 618, and the choke valve 118 are disposed in this order from the buffer tank 108 side. In the first branching flow passage 210, the first filter 615, the first pump 601, and the first conduit section 605 are disposed in this order from the buffer tank 108 side. In the second branching flow passage 220, the second filter 616, the second pump 602, and the second conduit section 606 are disposed in this order from the buffer tank 108 side. In the third branching flow passage 230, the third filter 617, the third pump 603, and the third conduit section 607 are disposed in this order from the buffer tank 108 side.

The heat exchanger 111 and a temperature regulator 112 have the same configurations as those of the heat exchanger 111 and the temperature regulator 112 of the first embodiment. The deaeration module 113 and a pressure-reducing pump 114 have the same configurations as those of the deaeration module 113 and the pressure-reducing pump 114 of the first embodiment.

The first filter 615 has the same configuration as that of the first filter 115 of the first embodiment. The second filter 616 has the same configuration as that of the second filter 116 of the first embodiment. The third filter 617 captures sticking matter formed in the third branching flow passage 230 and foreign matter mixed into the ink, thereby suppressing the sticking matter and foreign matter from being mixed into the printing head 21.

The first pump 601 has the same configuration as that of the first pump 101 of the first embodiment. The second pump 602 has the same configuration as that of the second pump 102 of the first embodiment. The third pump 603 sends ink stored in the buffer tank 108 to the printing head 21 through the third conduit section 607 disposed in the supply channel 200 (third branching flow passage 230). The first to third pumps 601 to 603 are configured using diaphragm pumps, for example.

The first conduit section 605 has the same configuration as that of the first conduit section 105 of the first embodiment. The second conduit section 606 has the same configuration as that of the second conduit section 106 of the first embodiment. The cross-section area of the internal space of the third conduit section 607 is larger than the cross-section area of the third branching flow passage 230. This allows the third conduit section 607 to reduce pulsation generated as the third pump 603 sends the ink.

The fourth filter 618 has a function to filter ink containing foreign matter of about several μm in size between the first to third branching flow passages 210 to 230 and the choke valve 118 in the supply channel 200. The fourth filter 618 captures sticking matter, foreign matter, and the like that are not captured by the first to third filters 615 to 617, thereby suppressing the sticking matter, foreign matter, and the like from being mixed into the printing head 21.

The choke valve 118 has the same configuration as that of the choke valve 118 of the first embodiment. The choke valve 118 is disposed in a portion of the supply channel 200 between the first to third conduit sections 605 to 607 (a junction 215 of the first branching flow passage 210, the second branching flow passage 220, and the third branching flow passage 230) and the printing head 21. As in the first embodiment, a temperature sensor 126 and a pressure sensor 127 are disposed in a portion of the supply channel 200 between the choke valve 118 and the printing head 21.

The supply-side air communicating channel 250 and the relief channel 260 have the same configurations as those of the supply-side air communicating channel 250 and the relief channel 260 of the first embodiment. The supply-side air communicating channel 250 branches off from a portion of the supply channel 200 between the fourth filter 618 (the junction 215 of the first branching flow passage 210, the second branching flow passage 220, and the third branching flow passage 230) and the choke valve 118, and is connected to the buffer tank 108.

In the collecting channel 300, the fourth conduit section 608, the fourth pump 604, and the check valve 131 are disposed in this order from the printing head 21 side. The fourth conduit section 608 has the same configuration as that of the third conduit section 107 of the first embodiment. The fourth pump 604 has the same configuration as that of the third pump 103 of the first embodiment. As in the first embodiment, a flow rate sensor 136 is disposed in the collecting channel 300 between the check valve 131 and the buffer tank 108.

The collection-side air communicating channel 350 has the same configuration as that of the collection-side air communicating channel 350 of the first embodiment. The collection-side air communicating channel 350 branches off from a portion of the collecting channel 300 between the printing head 21 and the fourth conduit section 608, and is connected to the buffer tank 108.

The configuration of the circulation unit 600 is not limited to that described in the present embodiment. For example, the circulation unit 600 does not have to have a filter or a check valve. The circulation unit 600 does not have to have a temperature sensor. The recovery unit 160 has the same configuration as that of the recovery unit 160 of the first embodiment.

As described above, the first branching flow passage 210, the second branching flow passage 220, and the third branching flow passage 230 are provided with the first pump 601, the second pump 602, and the third pump 603. That is, pumps for sending ink to the printing head 21 are provided in a plurality of branching flow passages, respectively. This suppresses three-dimensional increase in size of the pumps in the plurality of branching flow passages, allowing the pumps (first pump 601, second pump 602, and third pump 603) to be arranged side by side along the direction in which the space capable of accommodating the pumps expands. As in the first embodiment, this makes it possible to increase the flow rate of the ink supplied to the printing head 21 while ensuring the pump installation space.

### <Ink Filling Operation>

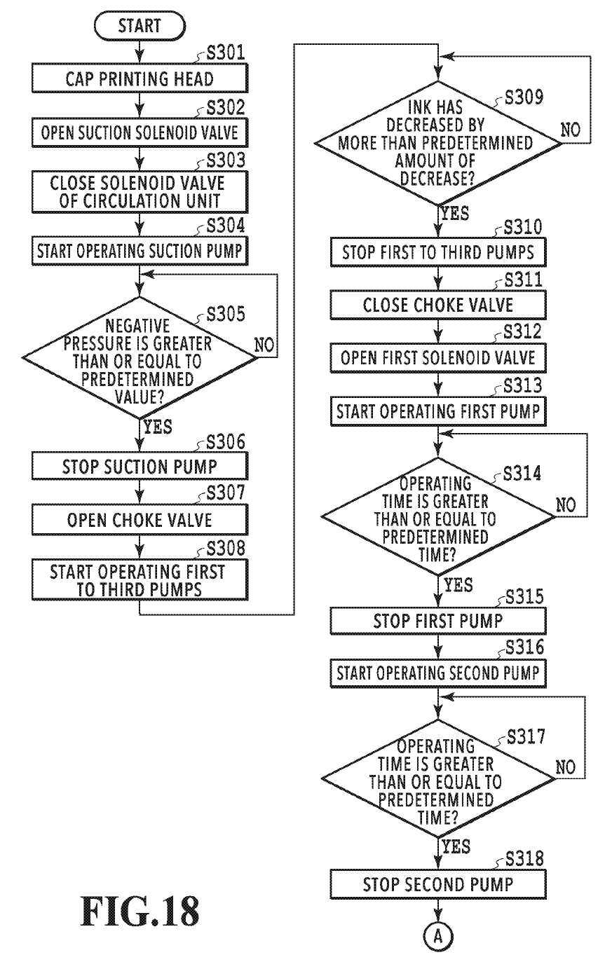

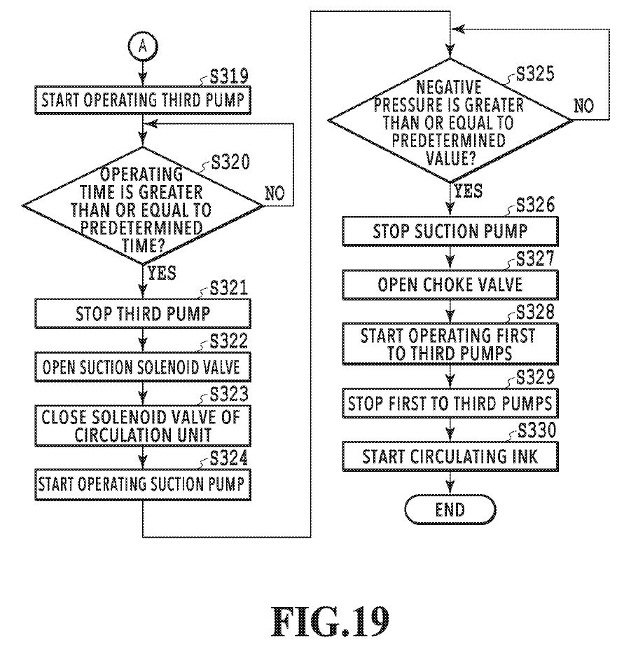

Next, an ink filling operation in the second embodiment will be described. FIGS. 18 and 19 are flowcharts showing a flow of the ink filling operation in the second embodiment. The ink filling operation is controlled by the printer control unit 501, the circulation control unit 505, and the like of the control unit 500. As in the first embodiment, the ink filling operation is performed upon first ink filling (initial filling) of the printing head 21 and the circulation liquid channel.

As shown in FIG. 18, first, in Step S301, the cap 161 of the recovery unit 160 caps the ejection surface 26 of the printing head 21. In this event, the printing head holding portion 22 and the like are operated to move the printing head 21 to the maintenance position above and near the cap 161. Once the printing head 21 is moved to the maintenance position, the cap 161 caps the ejection surface 26 of the printing head 21.

In the next Step, S302, the suction solenoid valve 165 of the recovery unit 160 opens the flow path in the suction pipe 163. With the cap 161 capping the ejection surface 26 of the printing head 21, the suction solenoid valve 165 opens the flow path in the suction pipe 163, allowing the recovery unit 160 to apply negative pressure to the circulation liquid channel through the printing head 21.

In Step S303, the choke valve 118 and the first solenoid valve 121 of the circulation unit 600 close a part of the circulation liquid channel. In this event, the choke valve 118 closes the supply channel 200 in the circulation liquid channel. The first solenoid valve 121 closes the supply-side air communicating channel 250. Note that the order of Steps S302 and S303 may be reversed. Steps S302 and S303 may be performed in parallel. Furthermore, the second solenoid valve 132 may close or open the collection-side air communicating channel 350.

In the next Step S304, the suction pump 162 of the recovery unit 160 starts its operation. With the flow path in the suction pipe 163 opened by the suction solenoid valve 165, the operation of the suction pump 162 causes negative pressure to act on the circulation liquid channel (supply channel 200) through the printing head 21. The magnitude of the negative pressure acting on the supply channel 200 is detected by the pressure sensor 127.

In the next Step S305, the circulation control unit 505 determines whether the magnitude (pressure value) of the negative pressure detected by the pressure sensor 127 is greater than or equal to a predetermined value. If the pressure value detected by the pressure sensor 127 is less than the predetermined value, that is, if the determination result in Step S305 is NO, the processing of Step S305 is repeated. If the pressure value detected by the pressure sensor 127 is greater than or equal to the predetermined value, that is, if the determination result in Step S305 is YES, the processing proceeds to Step S306. If Step S305 is executed a predetermined number of times, or if the determination result is NO even after a predetermined time has elapsed since the start of Step S304, the CPU 511 executes processing to notify the user of an error due to a problem with the ink supply. For example, the CPU 511 displays the error on the operation panel.

In Step S306, the suction pump 162 of the recovery unit 160 stops. In this event, with the supply channel 200 closed by the choke valve 118 of the circulation unit 600, negative pressure acts on the printing head 21 and the circulation liquid channel (supply channel 200).

In the next Step, S307, the choke valve 118 opens the supply channel 200. This allows ink to flow from the buffer tank 108 to the supply channel 200 by using the negative pressure applied to the supply channel 200 through the printing head 21.

In the next Step S308, the first to third pumps 601 to 603 of the circulation unit 600 start their operation. With the choke valve 118 opened and the first solenoid valve 121 closed, the operation of the first to third pumps 601 to 603 fills the supply channel 200 with the ink stored in the buffer tank 108. In addition, the weight of the buffer tank 108 in which the ink is stored is detected by a weight sensor (not shown).

The operations of Steps S301 to S308 are also referred to as choke suction. With no ink in the circulation liquid channel (supply channel 200), the first to third pumps 601 to 603 have difficulty suctioning the ink, making it difficult to fill the printing head 21 and the circulation liquid channel with the ink. In the present embodiment, the recovery unit 160 applies negative pressure to the circulation liquid channel through the printing head 21, making it possible to improve the ability to fill the printing head 21 and the circulation liquid channel with the ink.

In the next Step, S309, the circulation control unit 505 determines whether the weight detected by the weight sensor has decreased by more than a predetermined amount of decrease. The amount of decrease in weight detected by the weight sensor corresponds to the amount of decrease in weight of the ink stored in the buffer tank 108. The predetermined amount of decrease is set to an ink filling amount (weight) in the supply channel 200 such that the first to third pumps 601 to 603 are filled with the ink but the choke valve 118 is not filled with the ink. If the weight detected by the weight sensor has not decreased by more than the predetermined amount of decrease, that is, if the determination result in Step S309 is NO, the processing of Step S309 is repeated. If the weight detected by the weight sensor has decreased by more than the predetermined amount of decrease, that is, if the determination result in Step S309 is YES, the processing proceeds to Step S310. If Step S309 is executed a predetermined number of times, or if the determination result is NO even after a predetermined time has elapsed since the start of Step S308, the CPU 511 executes processing to notify the user of an error due to a problem with the ink supply. For example, the CPU 511 displays the error on the operation panel.

In Step S310, the first to third pumps 601 to 603 of the circulation unit 600 stop. In this event, the pressure inside the supply channel 200 is released to atmospheric pressure.

As in the first embodiment, the first to third pumps 601 to 603 are filled with ink by the first choke suction. It is preferable that the first choke suction fills the supply channel 200 with the ink up to just before the choke valve 118. To avoid air bubbles from entering the negative pressure control unit 420, the ink filling amount in the first choke suction is set to a filling amount such that the first to third pumps 601 to 603 are filled with the ink but the choke valve 118 is not filled with the ink.

In the first choke suction, the ink sent from the first to third pumps 601 to 603 is filled in the internal spaces of the first to third conduit sections 605 to 607, which are larger in cross-section area than the supply channel 200. This can suppress rapid ink filling in the supply channel 200, thus making it possible to avoid the supply channel 200 from being filled with the ink past the choke valve 118.

In the present embodiment, the ink filling amount in the first choke suction is managed based on, but not limited to, the amount of decrease in weight of the ink stored in the buffer tank 108. The ink filling amount in the first choke suction may also be managed based on the elapsed time since the start of the operation of the first to third pumps 601 to 603.

In the next Step S311, the choke valve 118 of the circulation unit 600 closes the supply channel 200. As described above, it is preferable that the supply channel 200 be filled with the ink up to the portion just before the choke valve 118.

In the next Step S312, the first solenoid valve 121 of the circulation unit 600 opens the supply-side air communicating channel 250. This causes the downstream side of the first branching flow passage 210, the second branching flow passage 220, and the third branching flow passage 230 to be communicated with the buffer tank 108 through the supply-side air communicating channel 250.

In the next Step S313, the first pump 601 of the circulation unit 600 starts its operation. In this case, out of the first to third pumps 601 to 603 (and the fourth pump 604), only the first pump 601 starts its operation. With the choke valve 118 closed and the first solenoid valve 121 opened, the ink stored in the buffer tank 108 passes through the supply channel 200 (first branching flow passage 210) and the supply-side air communicating channel 250 before returning to the buffer tank 108. Therefore, the operation of the first pump 601 circulates the ink through the supply channel 200 (first branching flow passage 210), the supply-side air communicating channel 250, and the buffer tank 108.

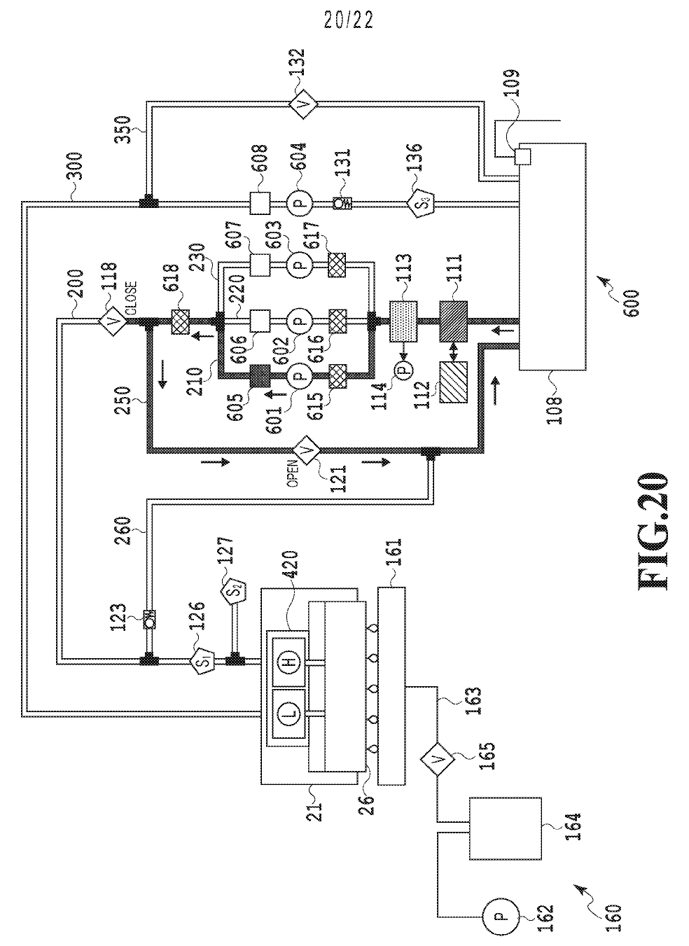

FIG. 20 is an explanatory diagram showing a state where, out of the first to third pumps 601 to 603, only the first pump 601 is in operation. As shown in FIG. 20, with only the first pump 601 in operation, no ink flows through the second branching flow passage 220, where the second pump 602 is not in operation. Similarly, no ink flows through the third branching flow passage 230, where the third pump 603 is not in operation. As a result, air bubbles present in the first branching flow passage 210, where the first pump 601 is in operation, are discharged to the buffer tank 108 through the first branching flow passage 210 and the supply-side air communicating channel 250.

Referring back to FIG. 18, in the next Step S314, the circulation control unit 505 determines whether the operating time of the first pump 601 is greater than or equal to a predetermined time. If the operating time of the first pump 601 is less than the predetermined time, that is, if the determination result in Step S314 is NO, the processing of Step S314 is repeated. If the operating time of the first pump 601 is greater than or equal to the predetermined time, that is, if the determination result in Step S314 is YES, the processing proceeds to Step S315.

In Step S315, the first pump 601 of the circulation unit 600 stops. This stops the ink circulation by the first pump 601.

In the next Step S316, the second pump 602 of the circulation unit 600 starts its operation. In this case, out of the first to third pumps 601 to 603 (and the fourth pump 604), only the second pump 602 starts its operation. With the choke valve 118 closed and the first solenoid valve 121 opened, the ink stored in the buffer tank 108 passes through the supply channel 200 (second branching flow passage 220) and the supply-side air communicating channel 250 before returning to the buffer tank 108. Therefore, the operation of the second pump 602 circulates the ink through the supply channel 200 (second branching flow passage 220), the supply-side air communicating channel 250, and the buffer tank 108.

As with the first pump 601, with only the second pump 602 in operation, no ink flows through the first branching flow passage 210, where the first pump 601 is not in operation. Similarly, no ink flows through the third branching flow passage 230, where the third pump 603 is not in operation. As a result, air bubbles present in the second branching flow passage 220, where the second pump 602 is in operation, are discharged to the buffer tank 108 through the second branching flow passage 220 and the supply-side air communicating channel 250.

In the next Step S317, the circulation control unit 505 determines whether the operating time of the second pump 602 is greater than or equal to a predetermined time. If the operating time of the second pump 602 is less than the predetermined time, that is, if the determination result in Step S317 is NO, the processing of Step S317 is repeated. If the operating time of the second pump 602 is greater than or equal to the predetermined time, that is, if the determination result in Step S317 is YES, the processing proceeds to Step S318.

In Step S318, the second pump 602 of the circulation unit 600 stops. This stops the ink circulation by the second pump 602.

As shown in FIG. 19, in the next Step S319, the third pump 603 of the circulation unit 600 starts its operation. In this case, out of the first to third pumps 601 to 603 (and the fourth pump 604), only the third pump 603 starts its operation. With the choke valve 118 closed and the first solenoid valve 121 opened, the ink stored in the buffer tank 108 passes through the supply channel 200 (third branching flow passage 230) and the supply-side air communicating channel 250 before returning to the buffer tank 108. Therefore, the operation of the third pump 603 circulates the ink through the supply channel 200 (third branching flow passage 230), the supply-side air communicating channel 250, and the buffer tank 108.

As with the first pump 601, with only the third pump 603 in operation, no ink flows through the first branching flow passage 210, where the first pump 601 is not in operation. Similarly, no ink flows through the second branching flow passage 220, where the second pump 602 is not in operation. As a result, air bubbles present in the third branching flow passage 230, where the third pump 603 is in operation, are discharged to the buffer tank 108 through the third branching flow passage 230 and the supply-side air communicating channel 250. The operation of the first to third pumps 601 to 603 circulates the ink through the supply channel 200, the supply-side air communicating channel 250, and the buffer tank 108, thereby filling the supply channel 200 and the supply-side air communicating channel 250 with the ink. Furthermore, by sequentially operating the first to third pumps 601 to 603 to circulate the ink, air bubbles present in the supply channel 200 up to just before the choke valve 118 can be discharged to the buffer tank 108 through the supply-side air communicating channel 250.

In the next Step S320, the circulation control unit 505 determines whether the operating time of the third pump 603 is greater than or equal to a predetermined time. If the operating time of the third pump 603 is less than the predetermined time, that is, if the determination result in Step S320 is NO, the processing of Step S320 is repeated. If the operating time of the third pump 603 is greater than or equal to the predetermined time, that is, if the determination result in Step S320 is YES, the processing proceeds to Step S321.

In Step S321, the third pump 603 of the circulation unit 600 stops. This stops the ink circulation by the third pump 603. Note that only the first pump 601 is operated first in the present embodiment, but only another pump may be operated first.

In Step S322, the suction solenoid valve 165 of the recovery unit 160 opens the flow path in the suction pipe 163. With the cap 161 capping the ejection surface 26 of the printing head 21, the suction solenoid valve 165 opens the flow path in the suction pipe 163, allowing the recovery unit 160 to apply negative pressure to the circulation liquid channel through the printing head 21.

In Step S323, the choke valve 118 and the first solenoid valve 121 of the circulation unit 600 close part of the circulation liquid channel. In this event, the choke valve 118 closes the supply channel 200 filled with ink up to just before the choke valve 118. The first solenoid valve 121 closes the supply-side air communicating channel 250 filled with ink. Note that the order of Steps S322 and S323 may be reversed. Steps S322 and S323 may also be performed in parallel. Furthermore, the second solenoid valve 132 may close or open the collection-side air communicating channel 350.

In the next Step S324, the suction pump 162 of the recovery unit 160 starts its operation. With the flow path in the suction pipe 163 opened by the suction solenoid valve 165, the operation of the suction pump 162 causes negative pressure to act on the circulation liquid channel (supply channel 200) through the printing head 21. The magnitude of the negative pressure acting on the supply channel 200 is detected by the pressure sensor 127.

In the next Step S325, the circulation control unit 505 determines whether the magnitude (pressure value) of the negative pressure detected by the pressure sensor 127 is greater than or equal to a predetermined value. If the pressure value detected by the pressure sensor 127 is less than the predetermined value, that is, if the determination result in Step S325 is NO, the processing of Step S325 is repeated. If the pressure value detected by the pressure sensor 127 is greater than or equal to the predetermined value, that is, if the determination result in Step S325 is YES, the processing proceeds to Step S326. If Step S325 is executed a predetermined number of times, or if the determination result is NO even after a predetermined time has elapsed since the start of Step S324, the CPU 511 executes processing to notify the user of an error due to a problem with the ink supply. For example, the CPU 511 displays the error on the operation panel.

In Step S326, the suction pump 162 of the recovery unit 160 stops. In this event, with the supply channel 200 closed by the choke valve 118 of the circulation unit 600, negative pressure acts on the printing head 21 and the circulation liquid channel (supply channel 200).

In the next Step S327, the choke valve 118 opens the supply channel 200. This allows ink to flow through the portion of the supply channel 200 downstream of the choke valve 118 by using the negative pressure applied to the supply channel 200 through the printing head 21.

In the next Step S328, the first to third pumps 601 to 603 of the circulation unit 600 start their operation. With the choke valve 118 opened and the first solenoid valve 121 closed, the operation of the first to third pumps 601 to 603 fills the supply channel 200 and the printing head 21 with the ink stored in the buffer tank 108.

In the next Step S329, the first to third pumps 601 to 603 of the circulation unit 600 stop. The operations of Steps S322 to S329 are also referred to as second choke suction. The ink filling amount in the second choke suction may be managed based on the amount of decrease in weight of the ink stored in the buffer tank 108. The ink filling amount in the second choke suction may also be managed based on the elapsed time since the start of the operation of the first to third pumps 601 to 603.

As in the first embodiment, as the second choke suction is performed, gas (air) remaining in the supply channel 200 is first discharged. Next, the ink in the supply channel 200 is discharged from the choke valve 118 to the cap 161 of the recovery unit 160 through the downstream side of the supply channel 200 and the inside of the printing head 21. This makes it possible to suppress air bubbles from entering the negative pressure control unit 420 of the printing head 21 during the ink filling operation.

Then, in Step S330, the first pump 601, the second pump 602, the third pump 603, and the fourth pump 604 of the circulation unit 600 start their operation. In this event, the choke valve 118 opens the supply channel 200. The first solenoid valve 121 closes the supply-side air communicating channel 250. The second solenoid valve 132 closes the collection-side air communicating channel 350. The operation of the first pump 601, the second pump 602, the third pump 603, and the fourth pump 604 also fills the collecting channel 300 with ink through the supply channel 200 and the printing head 21. The ink filling operation is thus completed, and the ink starts circulating through the circulation liquid channel. The first to third pumps 601 to 603 provided in the first to third branching flow passages supply ink to the printing head 21 at a higher flow rate than a pump provided in a supply channel consisting of only one channel.

Furthermore, the first to fourth conduit sections 605 to 608 are arranged along a direction in which the ink flows from the lower side to the upper side in the vertical direction. This suppresses generation of relatively large air bubbles inside the first to fourth conduit sections 605 to 608, thus making it possible to suppress air bubbles from entering the inside (negative pressure control unit 420) of the printing head 21. The first to fourth conduit sections 605 to 608 are also larger in cross-section area than the supply channel 200 and the collecting channel 300. This can reduce pulsation generated as the first to third pumps 601 to 603 send the ink, as well as pulsation of ink discharged from the printing head 21. Furthermore, even if the ink and the gas mix in the supply channel 200 during the ink filling operation, air bubbles can be contained inside the first to third conduit sections 605 to 607, thus suppressing the air bubbles from entering the inside of the printing head 21.

### <Deaeration Operation>

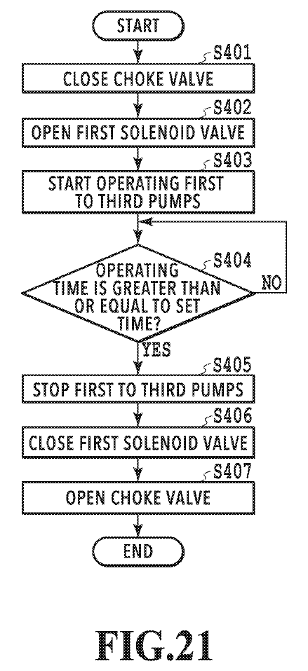

Next, a deaeration operation in the second embodiment will be described. FIG. 21 is a flowchart showing a flow of the deaeration operation in the second embodiment. The deaeration operation is controlled by the printer control unit 501, the circulation control unit 505, and the like of the control unit 500. The deaeration operation may be performed, for example, before the first pump 601, the second pump 602, the third pump 603, and the fourth pump 604 start their operation after the second choke suction during the ink filling operation. The deaeration operation may also be performed every predetermined elapsed time (for example, two hours) after the ink filling operation.

First, in Step S401, the choke valve 118 of the circulation unit 600 closes the supply channel 200.

In the next Step S402, the first solenoid valve 121 of the circulation unit 600 opens the supply-side air communicating channel 250. As a result, the downstream side of the first branching flow passage 210, the second branching flow passage 220, and the third branching flow passage 230 is communicated with the buffer tank 108 through the supply-side air communicating channel 250. The order of Steps S401 and S402 may be reversed. Steps S401 and S402 may be performed in parallel.

In the next Step S403, the first to third pumps 601 to 603 of the circulation unit 600 start their operation. With the choke valve 118 closed and the first solenoid valve 121 opened, the ink stored in the buffer tank 108 passes through any one of the first to third branching flow passages before returning to the buffer tank 108 through the supply-side air communicating channel 250. Therefore, the operation of the first to third pumps 601 to 603 circulates the ink through the supply channel 200 (first branching flow passage 210, second branching flow passage 220, and third branching flow passage 230), the supply-side air communicating channel 250, and the buffer tank 108.

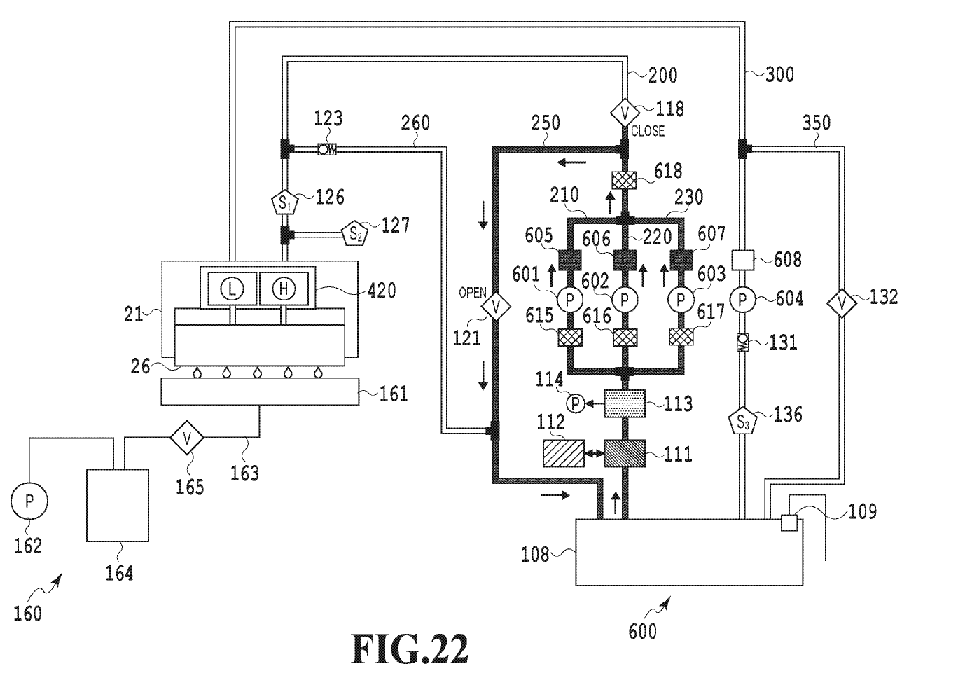

FIG. 22 is an explanatory diagram showing a state where the first to third pumps 601 to 603 are in operation during the deaeration operation. As shown in FIG. 22, air bubbles present in the first branching flow passage 210, where the first pump 601 is in operation, are discharged to the buffer tank 108 through the first branching flow passage 210 and the supply-side air communicating channel 250. Similarly, air bubbles present in the second branching flow passage 220, where the second pump 602 is in operation, are discharged to the buffer tank 108 through the second branching flow passage 220 and the supply-side air communicating channel 250. Similarly, air bubbles present in the third branching flow passage 230, where the third pump 603 is in operation, are discharged to the buffer tank 108 through the third branching flow passage 230 and the supply-side air communicating channel 250.

Referring back to FIG. 21, in the next Step S404, the circulation control unit 505 determines whether the operating time of the first to third pumps 601 to 603 is greater than or equal to a predetermined set time. If the operating time of the first to third pumps 601 to 603 is less than the set time, that is, if the determination result in Step S404 is NO, the processing of Step S404 is repeated. If the operating time of the first to third pumps 601 to 603 is greater than or equal to the set time, that is, if the determination result in Step S404 is YES, the processing proceeds to Step S405.

In Step S405, the first to third pumps 601 to 603 of the circulation unit 600 stop. This stops the ink circulation by the first to third pumps 601 to 603.

In the next Step S406, the first solenoid valve 121 of the circulation unit 600 closes the supply-side air communicating channel 250.

Then, in Step S407, the choke valve 118 of the circulation unit 600 opens the supply channel 200. The deaeration operation is thus completed. Note that the order of Steps S406 and S407 may be reversed. Steps S406 and S407 may also be performed in parallel.

As described above, according to the second embodiment, the flow rate of ink (liquid) supplied to the printing head 21 can be increased while ensuring the pump installation space as in the first embodiment.

As in the first embodiment, after the first choke suction, the control unit 500 controls any one of the plurality of pumps to operate with the supply channel 200 closed by the choke valve 118 and the supply-side air communicating channel 250 opened by the first solenoid valve 121. The control unit 500 then performs control to operate any one of the plurality of pumps (first to third pumps 601 to 603) for all of the plurality of pumps. Once the ink filling operation is completed, the control unit 500 controls the choke valve 118 to open the supply channel 200 and the first solenoid valve 121 to close the supply-side air communicating channel 250. This allows ink to flow through each of the plurality of branching flow passages (first to third branching flow passages), making it possible to fill each of the plurality of branching flow passages with ink.

As in the first embodiment, during the deaeration operation, the control unit 500 controls all of the plurality of pumps to operate with the supply channel 200 closed by the choke valve 118 and the supply-side air communicating channel 250 opened by the first solenoid valve 121. Once the deaeration operation is completed, the control unit 500 controls the choke valve 118 to open the supply channel 200 and the first solenoid valve 121 to close the supply-side air communicating channel 250. As a result, air bubbles present in the first branching flow passage 210, where the first pump 601 is in operation, are discharged to the buffer tank 108 through the first branching flow passage 210 and the supply-side air communicating channel 250. Similarly, air bubbles present in the second branching flow passage 220, where the second pump 602 is in operation, are discharged to the buffer tank 108 through the second branching flow passage 220 and the supply-side air communicating channel 250. Similarly, air bubbles present in the third branching flow passage 230, where the third pump 603 is in operation, are discharged to the buffer tank 108 through the third branching flow passage 230 and the supply-side air communicating channel 250. This makes it possible to remove the air bubbles present in the first branching flow passage 210, the second branching flow passage 220, or the third branching flow passage 230, thus suppressing air bubbles from entering the inside (negative pressure control unit 420) of the printing head 21.

The supply channel 200 has the first branching flow passage and the second branching flow passage in the first embodiment described above, and has the first to third branching flow passages in the second embodiment described above, but the present disclosure is not limited thereto. For example, the supply channel 200 may have a plurality of, four or more, branching flow passages. In this case, a pump and a conduit section are provided for each of the plurality of branching flow passages.

In the second embodiment described above, the first to fourth conduit sections 605 to 608 are disposed along the direction in which ink flows from the lower side to the upper side in the vertical direction, but the present disclosure is not limited thereto. For example, the first to fourth conduit sections 605 to 608 may also be disposed along the direction in which ink flows from the lower side to the upper side in a direction tilted relative to the vertical direction.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, the flow rate of a liquid supplied to the printing head can be increased while ensuring the pump installation space.

What is claimed is:

1. A printing apparatus comprising:
a printing head configured to eject a liquid to print an image;
a tank configured to store the liquid to be supplied to the printing head;
a supply channel connected to the printing head and the tank; and
a plurality of pumps configured to send the liquid stored in the tank to the printing head through the supply channel, wherein
the supply channel has a plurality of branching flow passages configured to branch off and merge midway through the supply channel, and
a pump from among the plurality of pumps is provided in each of the plurality of branching flow passages.

2. The printing apparatus according to claim 1, further comprising:
a control unit configured to control a filling operation for filling the printing head and the supply channel with the liquid, wherein
during the filling operation, the control unit performs control to operate any one of the plurality of pumps.

3. The printing apparatus according to claim 2, further comprising:
a choke valve provided between the printing head and a junction of the plurality of branching flow passages in the supply channel; and
a communicating channel configured to branch off from a portion of the supply channel between the choke valve and the junction and connected to the tank, wherein
during the filling operation, the control unit controls any one of the plurality of pumps to operate with the supply channel closed by the choke valve.

4. The printing apparatus according to claim 3, wherein
the control unit controls the choke valve to open the supply channel once the filling operation is completed.

5. The printing apparatus according to claim 3, further comprising:
a solenoid valve provided in the communicating channel, wherein
during the filling operation, the control unit controls any one of the plurality of pumps to operate with the supply channel closed by the choke valve and the communicating channel opened by the solenoid valve.

6. The printing apparatus according to claim 5, wherein
once the filling operation is completed, the control unit controls the choke valve to open the supply channel and the solenoid valve to close the communicating channel.

7. The printing apparatus according to claim 3, wherein
during a deaeration operation to remove air bubbles from the supply channel, the control unit controls all of the plurality of pumps to operate with the supply channel closed by the choke valve.

8. The printing apparatus according to claim 7, wherein
once the deaeration operation is completed, the control unit controls the choke valve to open the supply channel.

9. The printing apparatus according to claim 5, wherein
during a deaeration operation to remove air bubbles from the supply channel, the control unit controls all of the plurality of pumps to operate with the supply channel closed by the choke valve and the communicating channel opened by the solenoid valve.

10. The printing apparatus according to claim 9, wherein
once the deaeration operation is completed, the control unit controls the choke valve to open the supply channel and the solenoid valve to close the communicating channel.

11. A printing apparatus comprising:
a printing head configured to eject a liquid to print an image;
a tank configured to store the liquid to be supplied to the printing head;
a supply channel connected to the printing head and the tank;
a pump configured to send the liquid stored in the tank to the printing head through the supply channel;
a choke valve provided in the supply channel between the pump and the printing head;
a communicating channel configured to branch off from a portion of the supply channel between the choke valve and the pump and connected to the tank; and
a control unit configured to control a deaeration operation to remove air bubbles from the supply channel, wherein
during the deaeration operation, the control unit controls the pump to operate with the supply channel closed by the choke valve.

12. The printing apparatus according to claim 11, wherein
once the deaeration operation is completed, the control unit controls the choke valve to open the supply channel.

13. The printing apparatus according to claim 11, further comprising:
a solenoid valve provided in the communicating channel, wherein
during the deaeration operation, the control unit controls the pump to operate with the supply channel closed by the choke valve and the communicating channel opened by the solenoid valve.

14. The printing apparatus according to claim 13, wherein
once the deaeration operation is completed, the control unit controls the choke valve to open the supply channel and the solenoid valve to close the communicating channel.

15. The printing apparatus according to claim 11, wherein
the supply channel has a plurality of branching flow passages configured to branch off and merge midway through the supply channel,
a plurality of pumps are provided with a pump provided in each of the plurality of branching flow passages,
the choke valve is provided between the printing head and a junction of the plurality of branching flow passages in the supply channel, and
during the deaeration operation, the control unit controls all of the plurality of pumps to operate.
